(19) United States
(12) Patent Application Publication
(10) Pub. No.: US 2024/0259608 A1
(43) Pub. Date: Aug. 1, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Mehdi SALEHIFAR, Los Angeles, CA (US); Yuwen HE, Los Angeles, CA (US); Kai ZHANG, Los Angeles, CA (US); Na ZHANG, Beijing (CN); Li ZHANG, Los Angeles, CA (US)

(21) Appl. No.: 18/633,278

(22) Filed: Apr. 11, 2024

Related U.S. Application Data
(63) Continuation of application No. PCT/CN2022/124209, filed on Oct. 9, 2022.

(30) Foreign Application Priority Data
Oct. 11, 2021 (WO) PCT/CN2021/123141

(51) Int. Cl. H04N 19/88; H04N 19/176

(52) U.S. Cl. CPC H04N 19/88; H04N 19/176

(57) ABSTRACT

Embodiments of the present disclosure provide a solution for video processing. A method for video processing comprises: reordering, during a conversion between a current video block of a video and a bitstream of the video, a plurality of candidate signs of a motion vector difference (MVD) for a motion candidate of the current video block; and performing the conversion based on the reordered plurality of candidate signs. Compared with the conventional solution, the proposed method can advantageously improve coding efficiency and coding quality.

### CROSS REFERENCE

This application is a continuation of International Application No. PCT/CN2022/124209, filed on Oct. 9, 2022, which claims the benefit of International Application No. PCT/CN2021/123141 filed on Oct. 11, 2021. The entire contents of these applications are hereby incorporated by reference in their entireties.

### FIELD

Embodiments of the present disclosure relates generally to video coding techniques, and more particularly, to motion vector difference sign prediction and extended merge with motion vector difference (MMVD) reordering.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally expected to be further improved.

### SUMMARY

Embodiments of the present disclosure provide a solution for video processing.

In a first aspect, a method for video processing is proposed. The method comprises: reordering, during a conversion between a current video block of a video and a bitstream of the video, a plurality of candidate signs of a motion vector difference (MVD) for a motion candidate of the current video block; and performing the conversion based on the reordered plurality of candidate signs.

According to the method in accordance with the first aspect of the present disclosure, the candidate signs of MVD are reordered. Compared with the conventional solution where such reordering process is not utilized, the proposed method can advantageously improve coding efficiency and coding quality.

In a second aspect, another method for video processing is proposed. The method comprises: determining, during a conversion between a current video block of a video and a bitstream of the video, a first list of MVD candidates and a second list of MVD candidates for bi-prediction of the current video block, the first list being independent from the second list; and performing the conversion based on the first list and the second list.

According to the method in accordance with the second aspect of the present disclosure, the two MVD candidate lists for bi-prediction are independent from each other. Compared with the conventional solution where two MVD candidate lists for bi-prediction are correlated, the proposed method can advantageously improve coding efficiency and coding quality.

In a third aspect, an apparatus for processing video data is proposed. The apparatus for processing video data comprises a processor and a non-transitory memory with instructions thereon. The instructions, upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

In a fifth aspect, a non-transitory computer-readable recording medium is proposed. The non-transitory computer-readable recording medium stores a bitstream of a video which is generated by a method performed by a video processing apparatus. The method comprises: reordering a plurality of candidate signs of a motion vector difference (MVD) for a motion candidate of a current video block of the video; and generating the bitstream based on the reordered plurality of candidate signs.

In a sixth aspect, a method for storing a bitstream of a video is proposed. The method comprises: reordering a plurality of candidate signs of a motion vector difference (MVD) for a motion candidate of a current video block of the video; generating the bitstream based on the reordered plurality of candidate signs; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by a video processing apparatus. The method comprises: determining a first list of MVD candidates and a second list of MVD candidates for bi-prediction of a current video block of the video, the first list being independent from the second list; and generating the bitstream based on the first list and the second list.

In an eighth aspect, another method for storing a bitstream of a video is proposed. The method comprises: determining a first list of MVD candidates and a second list of MVD candidates for bi-prediction of a current video block of the video, the first list being independent from the second list; generating the bitstream based on the first list and the second list; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 illustrates a schematic diagram of MMVD search process;

FIG. 5 illustrates a schematic diagram of MMVD search point;

FIG. 6 illustrates a schematic diagram of simplified affine motion model;

FIG. 7 illustrates a schematic diagram of affine MVF per sub-block;

FIG. 8 illustrates a schematic diagram of distance index and distance offset mapping;

FIGS. 9A-9C illustrates some example implementations of adding diagonal angles, in FIG. 9A square dots represent new pi/4 diagonal angels, in FIG. 9B square and triangle dots represent the new pi/8 angels with roughly similar size, in FIG. 9C square and triangle dots represent the new pi/8 angels with different size;

FIGS. 10A and 10B illustrate some example implementations of adding diagonal angles with exact similar distance around a circle, in FIG. 10A square dots represent new pi/4 diagonal angels, in FIG. 10B square and triangle dots represent the new pi/8 angels;

FIG. 11 illustrates some example implementations of adding arbitrary combination of steps and angles asymmetrically;

FIG. 12 illustrates some example implementations of removing every other distance offset;

FIG. 13 illustrates a schematic diagram of proposed MV based dependent direction offset;

FIG. 14 illustrates a flowchart of a method for video processing in accordance with some embodiments of the present disclosure;

FIG. 15 illustrates a flowchart of a method for video processing in accordance with some embodiments of the present disclosure; and

FIG. 16 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

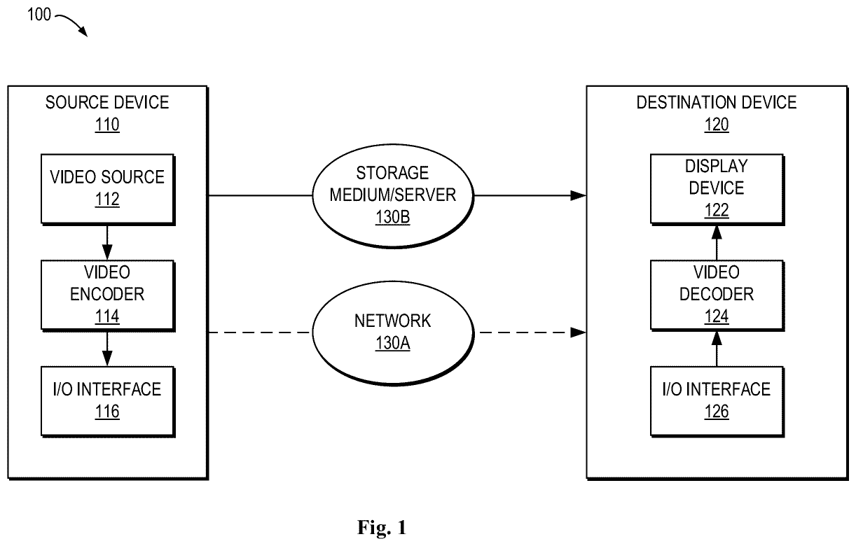

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

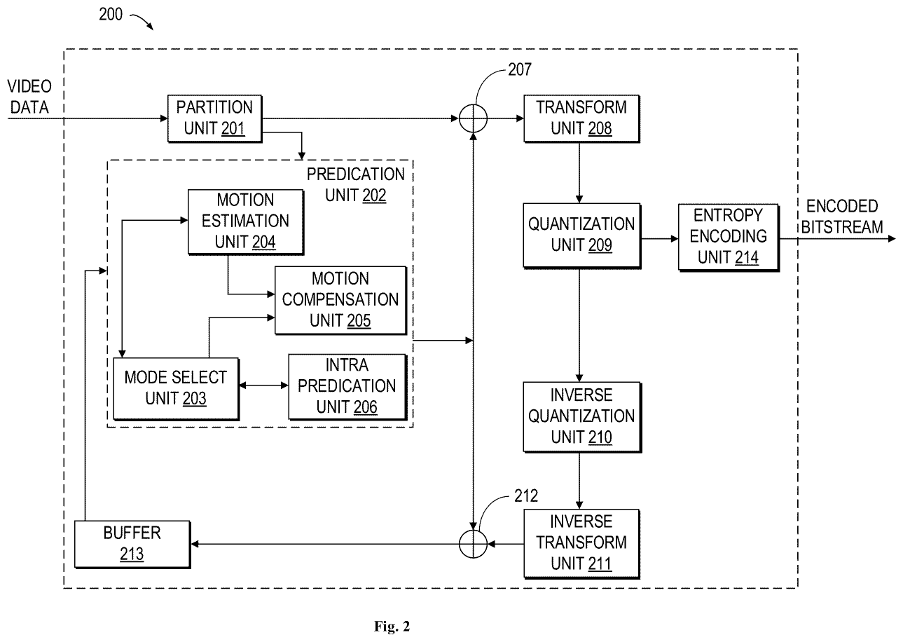

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

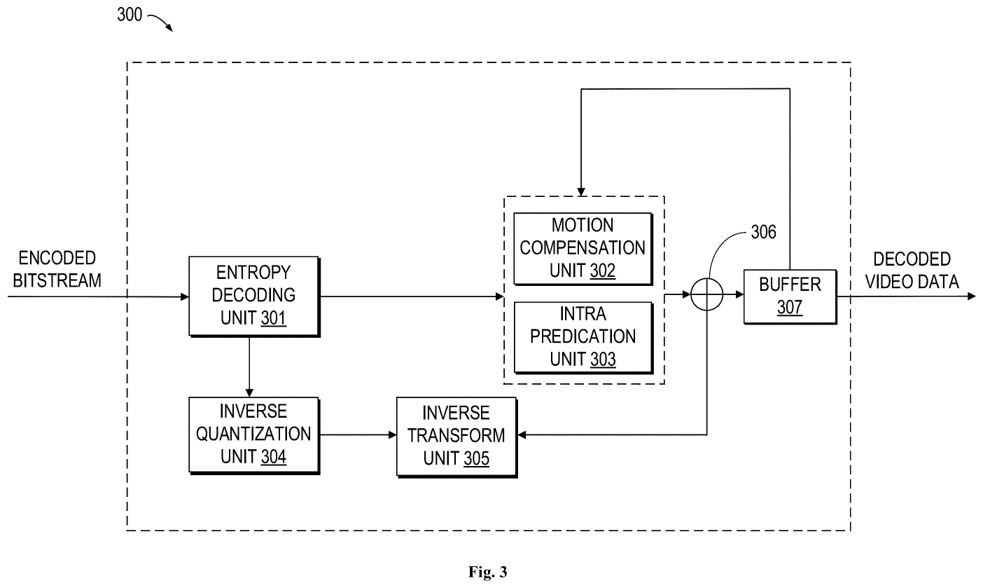

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video/image coding technologies. Specifically, it is related to MMVD. It may be applied to the existing video coding standard like HEVC, VVC, or the next generation video coding standard like beyond VVC exploration such as ECM. It may also be applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. As of July 2020, it has also finalized the Versatile Video Coding (VVC) standard, aiming at yet another 50% bit-rate reduction and providing a range of additional functionalities. After finalizing VVC, activity for beyond VVC has started. A description of the additional tools on top of the VVC has been summarized, and its reference SW is named as ECM.

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU. A prediction for MV called MVP will be subtracted from MV, to get MV difference (MVD). MVD have horizonal (MVx) and vertical (MVy) components which will be coded separately. For each MVx and MVy the signs coded independently in bypass mode. |MVx| and |MVy| also coded independently.

2.1 Merge with Motion Vector Difference (MMVD)

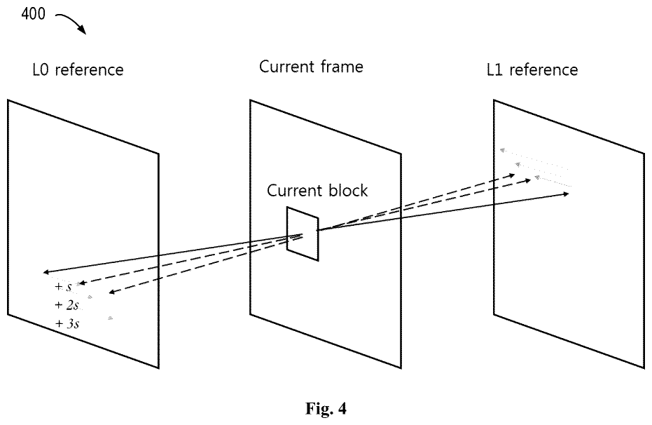

MMVD is used for either skip or merge modes with a proposed motion vector expression method. MMVD re-uses merge candidate as same as those included in the regular merge candidate list in VVC. Among the merge candidates, a base candidate can be selected, and is further expanded by the proposed motion vector expression method, FIG. 4. FIG. 4 illustrates a schematic diagram of MMVD search process.

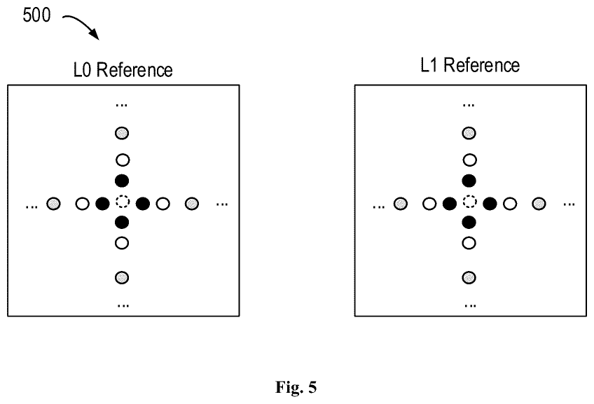

MMVD provides a new motion vector difference (MVD) representation method, in which a starting point, a motion magnitude and a motion direction are used to represent a MVD, FIG. 5. FIG. 5 illustrates a schematic diagram of MMVD search point. This MVD is referred to as a refinement or an offset. The size of this refinement in each x or y direction is referred to as a step size or distance offset, or simply a step.

This proposed technique uses a merge candidate list as it is. But only candidates which are default merge type (MRG_TYPE_DEFAULT_N) are considered for MMVD's expansion.

Base candidate index defines the starting point. Base candidate index indicates the best candidate among candidates in the table as follows.

TABLE 1
Base candidate IDX

| Base candidate IDX | 0 | 1 | 2 | 3 |
|---|---|---|---|---|
| N^{th} MVP | 1^{st} MVP | 2^{nd} MVP | 3^{rd} MVP | 4^{th} MVP |

If the number of base candidates is equal to 1, Base candidate IDX is not signaled.

Distance index is motion magnitude information. Distance index indicates the pre-defined distance from the starting point information. Pre-defined distance is shown in the table as follows:

TABLE 2a
Distance IDX

| | Distance IDX | | | | | | | |
|---|---|---|---|---|---|---|---|---|
| | 0 | 1 | 2 | 3 | 4 | 5 | 6 | 7 |
| Pixel distance | ¼- | ½- | 1- | 2- | 4- | 8- | 16- | 32- |
| | pel | pel | pel | pel | pel | pel | pel | pel |

The distance IDX is binarized in bins with the truncated unary code in the entropy coding procedure as shown in the table below:

TABLE 2b
Distance IDX Binarization

| | Distance IDX | | | | | | | |
|---|---|---|---|---|---|---|---|---|
| | 0 | 1 | 2 | 3 | 4 | 5 | 6 | 7 |
| Bins | 0 | 10 | 110 | 1110 | 11110 | 111110 | 1111110 | 1111111 |

In arithmetic coding, the first bin is coded with a probability context, and the following bins are coded with the equal-probability model, a.k.a. by-pass coding.

Direction index represents the direction of the MVD relative to the starting point. The direction index can represent of the four directions as shown in the table below.

TABLE 3
Direction IDX

| Direction IDX | 00 | 01 | 10 | 11 |
|---|---|---|---|---|
| x-axis | + | − | N/A | N/A |
| y-axis | N/A | N/A | + | − |

It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign specifies the sign of MV offset added to the list0 MV component of starting MV and the sign for the list1 MV has opposite value. Otherwise, if the difference of POC in list 1 is greater than list 0, the sign specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb. If the POC difference of L1 is greater than L0, the MVD for list 0 is scaled in the same way. If the starting MV is uni-predicted, the MVD is added to the available MV.

MMVD flag is signaled right after sending a skip flag or merge flag. If skip or merge flag is true, MMVD flag is parsed. If MMVD flage is equal to 1, MMVD syntaxes are parsed. But, if not 1, AFFINE flag is parsed. If AFFINE flag is equal to 1, that is AFFINE mode, But, if not 1, skip/merge index is parsed for VTM's skip/merge mode.

Additional line buffer due to MMVD candidates is not needed. Because a skip/merge candidate of software is directly used as a base candidate. Using input MMVD index, the supplement of MV is decided right before motion compensation. There is no need to hold long line buffer for this.

In current common test condition, either the first or the second merge candidate in the merge candidate list could be selected as the base candidate.

### 2.2 Affine Motion Compensation Prediction

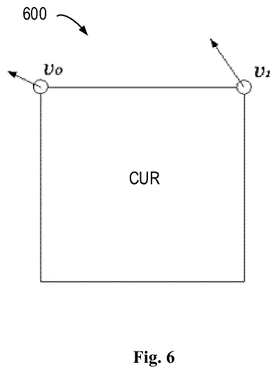

In HEVC, only translation motion model is applied for motion compensation prediction (MCP). While in the real world, there are many kinds of motion, e.g., zoom in/out, rotation, perspective motions and other irregular motions. In the JEM, a simplified affine transform motion compensation prediction is applied. As shown FIG. 6, the affine motion field of the block is described by two control point motion vectors.

The motion vector field (MVF) of a block is described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 1 )$$

Where (v₀ₓ, v_{0y}) is motion vector of the top-left corner control point, and (v₁ₓ, v_{1y}) is motion vector of the top-right corner control point.

In order to further simplify the motion compensation prediction, sub-block based affine transform prediction is applied. The sub-block size M×N is derived as in Equation 2, where MvPre is the motion vector fraction accuracy ( 1/16 in JEM), (v₂ₓ, v_{2y}) is motion vector of the bottom-left control point, calculated according to Equation 1.

$$\{ \begin{matrix}M = clip 3 ( 4 , w , \frac{w \times M v P r e}{max ( abs ( {v}_{1 x} - {v}_{0 x} ) , abs ( {v}_{1 y} - {v}_{0 y} ) )} ) \\ N = clip 3 ( 4 , h , \frac{h \times M v P r e}{max ( abs ( {v}_{2 x} - {v}_{0 x} ) , abs ( {v}_{2 y} - {v}_{0 y} ) )} )\end{matrix} \qquad ( 2 )$$

After derived by Equation 2, M and N should be adjusted downward if necessary to make it a divisor of w and h, respectively.

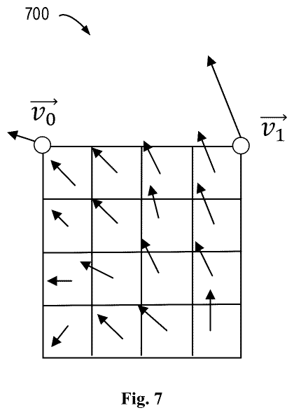

To derive motion vector of each M×N sub-block, the motion vector of the center sample of each sub-block, as shown in FIG. 7, is calculated according to Equation 1, and rounded to 1/16 fraction accuracy.

After MCP, the high accuracy motion vector of each sub-block is rounded and saved as the same accuracy as the normal motion vector.

2.3 Affine Merge Mode with Prediction Offsets

MMVD is extended to affine merge mode, this is referred to as affine MMVD mode thereafter. The proposed method selects the first available affine merge candidate as a base predictor. Then it applies a motion vector offset to each control point's motion vector value from the base predictor. If there's no affine merge candidate available, this proposed method will not be used.

The selected base predictor's inter prediction direction, and the reference index of each direction is used without change.

In the current implementation, the current block's affine model is assumed to be a 4-parameter model, only 2 control points need to be derived. Thus, only the first 2 control points of the base predictor will be used as control point predictors.

For each control point, a zero_MVD flag is used to indicate whether the control point of current block has the same MV value as the corresponding control point predictor. If zero_MVD flag is true, there's no other signaling needed for the control point. Otherwise, a distance index and an offset direction index is signaled for the control point.

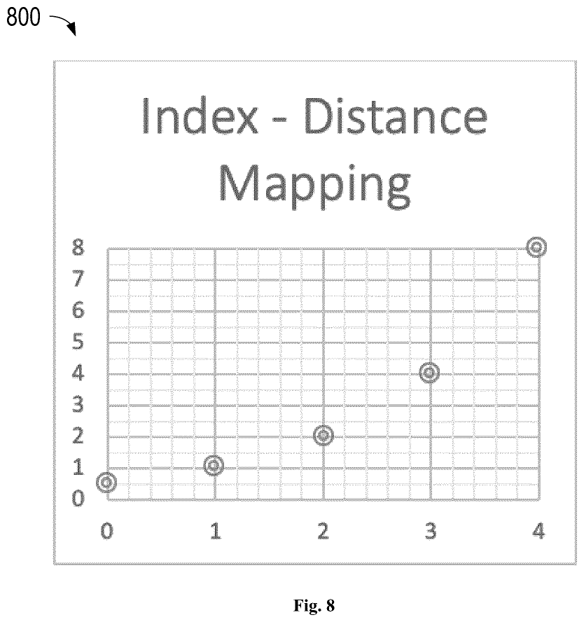

A distance offset table with size of 5 is used as shown in the table below. Distance index is signaled to indicate which distance offset to use. The mapping of distance index and distance offset values is shown in FIG. 8.

TABLE 4
Distance offset table

| Distance IDX | 0 | 1 | 2 | 3 | 4 |
|---|---|---|---|---|---|
| Distance-offset | ½-pel | 1-pel | 2-pel | 4-pel | 8-pel |

The direction index can represent four directions as shown in the table below, where only x or y direction may have an MV difference, but not in both directions.

TABLE 5
Direction index for four directions

| Offset Direction IDX | 00 | 01 | 10 | 11 |
|---|---|---|---|---|
| x-dir-factor | +1 | −1 | 0 | 0 |
| y-dir-factor | 0 | 0 | +1 | −1 |

If the inter prediction is uni-directional, the signaled distance offset is applied on the offset direction for each control point predictor. Results will be the MV value of each control point.

For example, when base predictor is uni-directional, and the motion vector values of a control point is MVP (vₚₓ, v_{py}). When distance offset and direction index are signaled, the motion vectors of current block's corresponding control points will be calculated as below.

$$M V ( {v}_{x} , {v}_{y} ) = MVP ( {v}_{p x} , {v}_{py} ) + MV ( x - dir - factor * distance - offset , y - dir - factor * distance - offset ) ;$$

If the inter prediction is bi-directional, the signaled distance offset is applied on the signaled offset direction for control point predictor's L0 motion vector; and the same distance offset with opposite direction is applied for control point predictor's L1 motion vector. Results will be the MV values of each control point, on each inter prediction direction.

For example, when base predictor is uni-directional, and the motion vector values of a control point on L0 is MVP_{L0} (v₀ₚₓ, v_{0py}), and the motion vector of that control point on L1 is MVP_{L1} (v₁ₚₓ, v_{1py}). When distance offset and direction index are signaled, the motion vectors of current block's corresponding control points will be calculated as below.

$${MV}_{L 0} ( {v}_{0 x} , {v}_{0 y} ) = M V {P}_{L 0} ( {v}_{0 px} , {v}_{0 py} ) + MV ( x - dir - factor * distance - offset , y - dir - factor * distance - offset ) ;$$

$$M {V}_{L 1} ( {v}_{0 x} , {v}_{0 y} ) = M V {P}_{L 1} ( {v}_{0 px} , {v}_{0 py} ) + MV ( - x - dir - factor * distance - offset , - y - dir - factor * distance - offset ) ;$$

2.4 GPM with MMVD

A geometry partition mode (GPM) with MMVD (called GPM_MMVD) was proposed to further improve the coding efficiency of the GPM mode in the VVC. Specifically, in those schemes, additional MV differences (MVDs) are further applied on top of the existing GPM merge candidates to improve the precision of the MVs used by the two GPM partitions. Moreover, to reduce the signaling overhead, the MVDs are signaled in the same manner as the merge mode with MVD (MMVD) in the VVC.

Specifically, two flags are signaled to separately indicate whether additional MVD is applied to each GPM partition. When the flag of one GPM partition is true, its corresponding MVD is signaled in the same way as the MMVD, i.e., one distance index plus one direction index. To enable more MV combinations, the merge indices of two GPM partitions are allowed to be the same when the MVDs that are applied to the two partitions are not identical. Additionally, an MV pruning procedure is introduced to construct the GPM merge candidate list when GPM with MMVD is applied.

Additionally, two different sets of MVDs are supported for the GPM which are selected according to one indication flag at picture header. When the flag is equal to 0, the existing MVD set used by the MMVD, which includes 8 distances {¼-pel, ½-pel, 1-pel, 2-pel, 4-pel, 8-pel, 16-pel, 32-pel} and 4 horizontal/vertical directions, are supported for the GPM CUs in the current picture; otherwise, another MVD set, which include 9 distance {¼-pel, ½-pel, 1-pel, 2-pel, 3-pel, 4-pel, 6-pel, 8-pel, 16-pel} and 8 directions (4 horizontal/vertical directions plus 4 diagonal directions), are applied.

### 2.5 Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, α*p[x]+β to compensate illumination changes, where p[x] is a reference sample pointed to by MV at a location x on reference picture. Since α and β can be derived based on current block template and reference block template, no signaling overhead is required for them, except that an LIC flag is signaled for AMVP mode to indicate the use of LIC.

The local illumination compensation proposed in JVET-00066 is used for uni-prediction inter CUs with the following modifications.
Intra neighbor samples can be used in LIC parameter derivation
LIC is disabled for blocks with less than 32 luma sample
For both non-subblock and affine modes, LIC parameter derivation is performed based on the template block samples corresponding to the current CU, instead of partial template block samples corresponding to first top-left 16×16 unit
Samples of the reference block template are generated by using MC with the block MV without rounding it to integer-pel precision.
   2.6 Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) ≫ 3$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. For further details readers are referred to the VTM software and document JVET-L0646. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g., equal weight.

### 3. Problems

There are several problems in the current MMVD design.
The number of the directions are limited. It is only limited to 4 directions and does not cover other directions.
The distance set is fixed and does not depend on the block size, or motion vector magnitude, or direction.
Coding direction and distance separately could be suboptimal if there is any strong correlation between them.
It does not use the neighboring block template information for deciding the refinement value (e.g. which direction(s) and/or distance(s) and/or base candidate(s) will be finally checked).

### 4. Detailed Solutions

The detailed embodiments below should be considered as examples to explain general concepts. These embodiments should not be interpreted in a narrow way. Furthermore, these embodiments can be combined in any manner.

The methods disclosed below may be applied to MMVD, and extensions of MMVD (e.g., the affine MMVD or GPM MMVD (GMVD), MMVD for IBC mode, MMVD for affine IBC mode). In the following descriptions, the terminology ‘MMVD’ may be utilized to represent a coding tool wherein partial of motion information (e.g., reference picture index, prediction direction from List 0/1, and base motion vectors) is inherited from a candidate while indication of some additional refinement of refined motion information (e.g., refined mv differences) is further signaled in the bitstream.

### On Extension of Directions Used in MMVD Design.

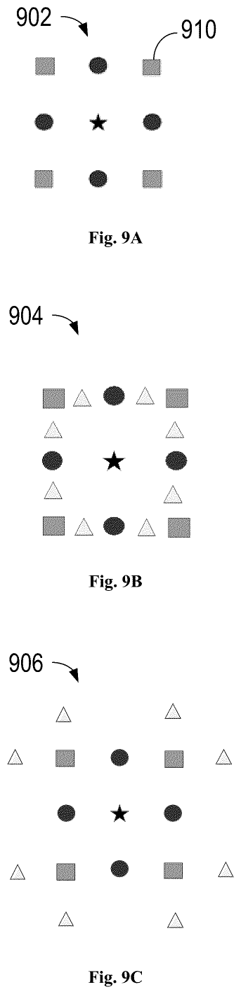

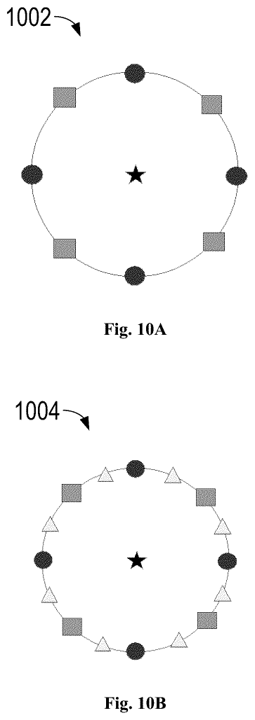

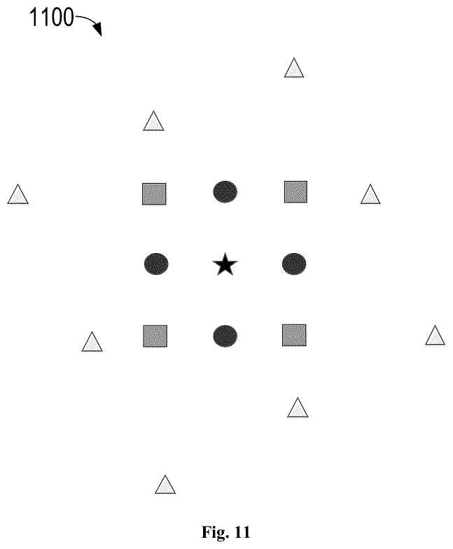

1. Slash/asymmetric directions or diagonal directions may be utilized for MMVD coded blocks.
   a. The diagonal direction may be defined as M*pi/N wherein M and N are both non-zero integers, M<N.
      i. In one example as depicted in FIG. 9A with square dot, at least one of the four diagonal direction positions could be added to the original four horizontal and vertical directions.
      ii. In one example as depicted in FIG. 9B with square dots and triangle dots, at least one of the additional 8 directions could be added to the previous 8 directions at angles k*pi/8.
      iii. In one example as depicted in FIG. 9C with square dots and triangle dots, at least one of the additional 8 directions could be added to the previous 8 directions at angles k*pi/8, with asymmetric distance offset.
      iv. In one example, at least one of the additional 16 directions could be added to the previous 16 directions at angles k*pi/16.
      v. In one example as depicted in FIG. 10 with square dots and triangle dots, at least one of the additional 4 or 8 directions could be added to the previous 4 or 8 directions at angles k*pi/8, with exact similar distance offset around a circle.
   b. Asymmetric angles and/or with asymmetric distances may be utilized in the MMVD design.
      i. One example is as depicted in FIG. 11, wherein square dots and triangle dots present the additional directions. FIG. 11 illustrates some example implementations of adding arbitrary combination of steps and angles asymmetrically.
   c. The directions mentioned above may be added as additional directions in addition to those in the prior art.
      i. Alternatively, it may be used to replace at least one of the existing directions defined in the prior art.
   d. In one example, the additional asymmetric/slash offset or additional diagonal directions for MMVD and/or its extensions (e.g., affine MMVD) may be indicated by an index to be coded jointly or separately for the directional and distance offsets.
      i. In one example, the index may be coded with truncated binary/binary code.
      ii. In one example, the index may be all coded using truncated unary code.
      iii. In one example, the index may be all coded using Rice or exponential Golomb code of order k which k could be 0, 1, or any number.
         (i) In one example, the rice code with parameter 1, 2, 4, 8 or any other number may be used.
      iv. In one example, the prefix and suffix of the codes may be coded in any combination of bypass and context coded bin.
      v. In one example, the index could be coded in bypass mode.
      vi. In one example, the index could be coded in context mode.
      vii. In one example, at least one bin of the index (such as only the first bin) may be context coded.
      viii. In one example, the first N bins may be context coded. The context coded may share the same context or have independent context.
2. Whether to and/or how many directions should be utilized may be signaled or derived on-the-fly (e.g., according to decoded information).
   a. In one example additional directions could be added only for some particular block sizes.
      i. In one example additional direction may be added to blocks with width*height>C1
         (i) An example for C1 could be 64 or 256.
      ii. In one example additional direction may be added to blocks with width*height<C1.
         (i) An example for C1 could be 64 or 256.
      iii. In one example additional direction may be added to blocks with width>C1 and/or height>C2.
         (i) An example for C1 and C2 could be 16 and 32 respectively.
      iv. In one example additional direction may be added to blocks with width<C1 and/or height<C2.
         (i) An example for C1 and C2 could be 16 and 32 respectively.
      v. The thresholds C1/C2 mentioned above may be pre-defined or signaled in the bitstream.
   b. In one example, whether to apply additional directions and/or which additional directions to be used may be based on the picture resolution and/or reference picture list and/or low-delay check flag.
   c. In one example, whether to apply additional directions and/or which additional directions to be used, may be signaled from an encoder to a decoder such as in SPS/PPS/VPS/APS/slice header/picture header/CTU/CU/PU, etc.
      i. For example, pictures at low temporal layers may use more directions, and/or pictures at high temporal layers may use fewer directions.

### On Extension of Distance Offsets Used in MMVD Design.

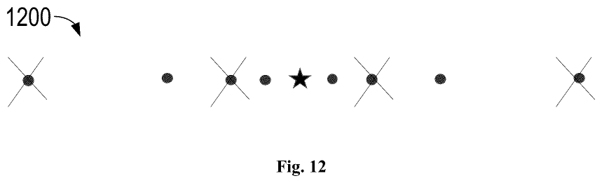

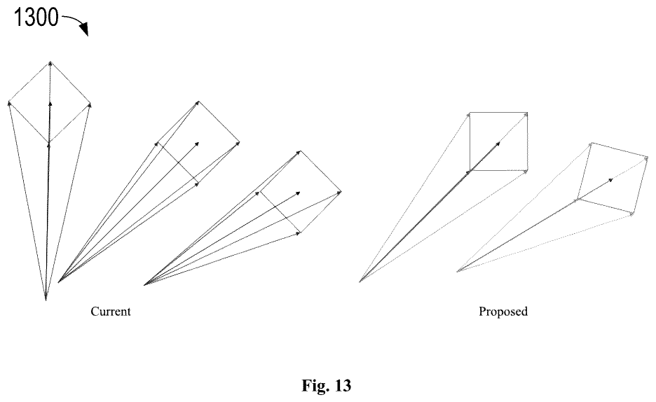

3. It is proposed that at least one extra distance could be added to or at least one existing distance could be removed from the original distance set (or candidate list) for MMVD mode and/or extensions of MMVD mode.
   a. It is proposed that at least one extra distance offset could be added to the original 8 distance offsets for MMVD and/or GMVD and 5 original distance offsets for Affine MMVD refinement candidates.
   b. Alternatively, at least one distance offset may be removed from the original 8 distance offsets for MMVD and 5 original distance offsets for Affine MMVD refinement candidates.
   c. In one example, at least one additional distance offset could be added between and/or beyond the original 8 MMVD distance offsets. The number of additional distance offsets could be 4 or 8 or any other number.
   d. In one example, at least one additional distance offset could be added between and/or beyond the original 5 Affine MMVD distance offsets. The number of additional distance offsets could be 4, 5, or 8 or any other number.
   e. In one example, at least one additional distance offset could be added only between two distance offsets, which are both smaller than a threshold.
   f. In one example, at least one additional distance offset could be added only between two distance offsets, which are both larger than a threshold.
   g. In one example some distance offsets could be removed, and the number of the distance offsets could be reduced to N (e.g. 3, or 4, or 5).
   h. In one example, every other distance offset could be removed starting removal from the 2^{nd} distance offset as depicted in FIG. 12. FIG. 12 illustrates some example implementations of removing every other distance offset.
   i. In one example, every other distance offset could be removed starting removal from the first distance offset.
   j. In one example, the first half distance offsets (e.g., idx 0, 1, 2, 3 for MMVD) could be removed.
   k. In one example, the second half (e.g., idx 4, 5, 6, 7 for MMVD) could be removed.
   l. In one example the final offsets which may be indicated as a joint index for all offsets or divided to 2 indexes for directional and distance offset, may be coded with Truncated unary code, or truncated binary code, or Rice code of parameter R or Exponential Golomb code of order k, with any combination of bypass and context coded bin.
4. The initial distance offset candidate list may be pre-defined or signaled or derived on-the-fly.
   a. In one example, depending on the block size, initial distance offset candidate list may be chosen.
      i. As an example, for blocks with width*height>C, one set of distance offsets are chosen and a different set is chosen for the remaining.
5. It is proposed that whether to apply additional direction(s) and/or additional offset(s), and/or which additional direction(s) and/or additional offset(s) should be applied, could be dependent on the original base motion vector direction and/or its magnitude, for MMVD and/or extensions of MMVD (e.g. Affine MMVD and/or GMVD).
   a. In one example, the initial offset could be determined by the base MV magnitude.
      i. MV magnitude may be derived by MVx and MVy. E.g., MV magnitude is calculated as |MVx|+|MVy|.
      ii. MV magnitude may be derived by MVx and MVy. E.g., MV magnitude is calculated as (MVx)\hat{ }2+(MVy)\hat{ }2.
      iii. If both the Ref0 and Ref1 are available, the magnitude may be a weighted average of the MV length of each of the Ref list MV.
      iv. For Affine MMVD, the top-left control point MV magnitude of the base affine MVs could be used to determine the initial offset with those methods specified in i, ii, iii.
   b. In one example, the initial distance offset for MV magnitude>C1 could be larger than the initial distance offset for MV magnitude<C1.
      i. In one example, the initial distance offset for MV magnitude>C1 could be N times of the initial distance offset for MV magnitude<C1, where C1 for example could be 50 pixels, and N for example could be 2.
   c. In one example, at least one directional offset could be derived from the base MV. For Affine MMVD, the top-left control point MV of the base affine MVs could be used to derive the additional directional offset.
      i. In one example, this directional offset could be precise, such as being parallel or perpendicular to that of the original base MV as depicted in FIG. 13. FIG. 13 illustrates a schematic diagram of proposed MV based dependent direction offset.
      ii. In one example, an additional directional offset could be approximated, such as if the base MV direction is between pi/8 and 3pi/8, diagonal directional offset could be used, otherwise vertical/horizontal directional offset would be used.
      iii. directional offsets may replace the offsets in the original design of MMVD/GMVD/affine MMVD.
         I. Alternatively, directional offsets may be added to be used together with the original design of MMVD/GMVD/affine MMVD.

### MMVD Reordering

6. It is proposed the base motion candidates and/or motion candidates after refinement (e.g., by adding the MVD) for MMVD mode and/or extensions of MMVD (e.g., the affine MMVD or GPM MMVD (GMVD), MMVD for IBC mode, MMVD for affine IBC mode) mode may be reordered.
   a. In one example, the reordering process should be performed before the MMVD refinement method being interpreted from at least one syntax elements.
   b. In one example, the N1 refinement steps as well as N2 directions as well as N3 base candidates which construct N1*N2*N3 possibilities may be reordered together.
      i. N1 may be 4, 5, 8, 16 or any other number. N2 may be 2, 4, 6, 8, 16, 32 or any other numbers. N3 maybe 1, 2, 3, 4, or any other numbers.
   c. In one example, N possible refinement positions (could be asymmetric for direction, or step, or no clear direction or steps) as well as N3 base candidates which construct N*N3 possibilities may be reordered together.
   d. In one example, the reordering process could be done for each base candidate separately.
      i. For example, the N1 refinement steps as well as N2 directions which construct N1*N2 possibilities may be reordered together, for each base candidate.
      ii. For example, if there are total of N possible refinement positions (could be asymmetric for direction, or step, or no clear direction or steps) may be reordered together, for each base candidate.
      iii. In one example, the base candidates may be reordered in advance. Afterwards, the refinement of the first base candidate is further applied.
         (i) For example, the N1 refinement steps as well as N2 directions which construct N1*N2 possibilities may be reordered together, for the first base candidate.
         (ii) For example, if there are total of N possible refinement positions (could be asymmetric for direction, or step, or no clear direction or steps) may be reordered together, for the first base candidate.
   e. In one example, the reordering process could be done for candidates with a same base candidate and a same direction separately. For example, the N1 refinement steps may be reordered together, for candidates with a same base candidate and a same direction independently.
   f. In one example, the reordering process could be done for candidates with a specified base candidate and a specified direction separately. For example, the N1 refinement steps may be reordered together, for candidates with a specified base candidate and a specified direction independently.
   g. In one example, the reordering process could be done for candidates with a same base candidate and a same refinement step separately. For example, the N2 directions may be reordered together, for candidates with a same base candidate and a same refinement step independently.
   h. In one example, the reordering process could be done for candidates with a specified base candidate and a specified refinement step separately. For example, the N2 directions may be reordered together, for candidates with a specified base candidate and a specified refinement step independently.
   i. In one example any subgroup of the possible options could be reordered just inside of that subgroup.
      i. In one example, the subgroup is divided from all the candidates for MMVD according to the direction.
      ii. In one example, the subgroup is divided from all the candidates for MMVD according to the distance.
      iii. In one example, the subgroup is divided from all the candidates for MMVD according to the base candidate.
      iv. In one example, the subgroup is divided from all the candidates for MMVD according to any combinations of direction, distance, and the base candidate.
   j. In one example reordering process may be applied sequentially based on the characteristics.
      i. As an example, first reordering process for base candidates may be performed. Next reordering process for directions may be performed with a fixed distance offset. Finally reordering process for the distance offsets may be performed.
      ii. Alternatively, first reordering process for base candidates may be performed. Next reordering process for each direction and distance combination with a same base candidate may be performed.
      iii. Alternatively, first reordering process for base candidates may be performed. Next reordering process for each direction and distance combination with a specified (e.g., the first) base candidate may be performed.
   k. In one example, the reordered MMVD and/or its extensions (e.g., affine MMVD) may be indicated by an index to be signaled,
      i. In one example, the index may be all coded using truncated unary code.
      ii. In one example, the index may be all coded using truncated binary/binary code.
      iii. In one example, the index may be all coded using Rice or exponential Golomb code of order k which k could be 0, 1, or any number.
         (i) In one example, the rice code with parameter 1, 2, 4, 8 or any other number may be used
      iv. In one example, the prefix and suffix of the codes may be coded in any combination of bypass and context coded bin
      v. In one example, the index could be coded in bypass mode.
      vi. In one example, the index could be coded in context mode.
      vii. In one example, at least one bin of the index (such as only the first bin) may be context coded
         (i) In one example, the first N bins may be context coded. The context coded may share the same context or have independent context.
   l. In one example, base candidate indexes may be coded separately such as in truncated unary or truncated binary in context or bypass coded bins. The remaining directions and distances may be coded as described above.
   m. In one example, after reordering the MMVD candidates, only the top N numbers with the lowest costs are kept. N could be any integers. Only the new limited options will be coded.
      i. In one example after reordering the MMVD candidates, only the top half with the lowest costs are kept. Only the new limited options will be coded.
      ii. In one example after reordering the MMVD candidates, only the top ¼^{th} with the lowest costs are kept. Only the new limited options will be coded.
      iii. In one example after reordering the MMVD candidates, only the top ⅛^{th} with the lowest costs are kept. Only the new limited options will be coded.
      iv. In one example after reordering the MMVD candidates, only the top 1/16^{th} with the lowest costs are kept. Only the new limited options will be coded.
   n. In one example, only candidates with cost smaller than F*bestCost may be selected. F maybe any number such as 1.2, 2, 2.5, . . . and bestCost is the best (e.g., smallest) template matching cost of the candidates.
   o. In one example, any combination of selecting candidates based on a fixed ratio from best template matching cost, or choosing top N, or limiting based on the block size and/or base MV magnitude and/or base MVdirection may be used.
   p. In one example, the reordering process may be limited to a special block size. As an example, reordering is applied for blocks with width*height>C, and reordering is not applied for the remaining.
   q. In one example, after reordering process, only the best MMVD candidate may be selected, and no additional index signaling may be necessary.
7. The reordering may be based on a template matching approach.
   a. In one example, the reorder criteria for the candidates may be template matching cost between a template around the current block and the reference for that template.
      i. In one example this cost may be Sum of Absolute Difference (SAD) between the template samples and their references.
      ii. In one example this cost may be Sum of Absolute Transformed Difference (SATD) or any other cost measure between the template samples and their references.
      iii. In one example this cost may be Mean Removal based Sum of Absolute Difference (MR-SAD) between the template samples and their references.
      iv. In one example this cost may be a weighted average of SAD/MR-SAD and SATD between the template samples and their references.
      v. In one example, the cost function between current template and reference template may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.
   b. The cost may consider the continuity (Boundary_SAD) between reference template and reconstructed samples adjacently or non-adjacently neighboring to current template in addition to the SAD calculated in (f). For example, reconstructed samples left and/or above adjacently or non-adjacently neighboring to current template are considered.
      i. In one example, the cost may be calculated based on SAD and Boundary_SAD.
         (i) In one example, the cost may be calculated as (SAD+w*Boundary_SAD). w may be pre-defined or signaled or derived according to decoded information.
   c. In one example K1 rows on the top and/or K2 columns on the left and/or K1*K2 samples/pixels on the corner may be used as the template.
      i. K1 and K2 could be any number; as an example, K1 and K2 could be 1, 2, 3, width/2, height/2, width, height.
      ii. Alternatively, only K1 rows on the top are used as the template.
      iii. Alternatively, only K2 columns on the left are used as the template.
      iv. Alternatively, K1 rows on the top and K2 columns on the left are used as the template.
   d. The template matching procedure may comprise one component such as luma.
      i. Alternatively, the template matching procedure may comprise multiple components such as luma and chroma.
         (i) In one example, the total template matching cost may be calculated as a weighted sum of template matching costs on different color components.
   e. In one example, the reference samples of the template (RT_{bi-pred}) for bi-directional prediction are derived by weighted averaging of the reference samples of the template in reference list0 (RT₀) and the reference samples of the template in reference list1 (RT₁). One example is as follows:

$$R T = ( ( {2}^{N} - w ) * R {T}_{0} + w * {RT}_{1} + {2}^{N - 1} ) ≫ N ,$$

for example, N=3.
f. In one example, the weight of the reference template in reference list0 such as (8−w) and the weight of the reference template in reference list1 such as (w) maybe decided by the BCW index of the merge candidate.
   i. In one example, BCW index is equal to 0, w is set equal to −2.
   ii. In one example, BCW index is equal to 1, w is set equal to 3.
   iii. In one example, BCW index is equal to 2, w is set equal to 4.
   iv. In one example, BCW index is equal to 3, w is set equal to 5.
   v. In one example, BCW index is equal to 4, w is set equal to 10.
g. In one example, if the Local Illumination Compensation (LIC) flag of the merge candidate is true, the reference samples of the template are derived with LIC method.
   i. Alternatively, the reference samples of the template are derived without LIC.
h. In one example, when deriving the reference samples of the template, the motion vectors of the merge candidate are rounded to the integer pixel accuracy, where the integer motion vector may be its nearest integer motion vector.
i. In one example, when deriving the reference samples of the template, N-tap interpolation filtering is used to get the reference samples of the template at sub-pixel positions. For example, N may be 2, 4, 6, 8, or 12.
8. Early termination of reordering process may be applied.
   a. In one example, only candidates associated with a certain direction may be further checked under certain conditions are satisfied.
   b. In one example, only candidates associated with a certain distance offset, but different directions may be further checked under certain conditions are satisfied.

### On MVD Sign Prediction

9. It is proposed a sign of MVD, for Advanced Motion Vector Prediction (AMVP) mode and/or its extensions (e.g., affine AMVP), MMVD mode and/or extensions of MMVD (e.g., the affine MMVD or GPM MMVD (GMVD), MMVD for IBC mode, MMVD for affine IBC mode) mode may be predicted (or reordered).
   a. In one example the sign of MVD horizonal component (MVx) may be predicted.
   b. In one example the sign of MVx may be predicted (reordered), and one flag is coded to determine whether the prediction is correct or not.
   c. In one example the sign of MVD vertical component (MVy) may be predicted.
   d. In one example the sign of MVy may be predicted (reordered), and one flag is coded to determine whether the prediction is correct or not.
   e. In one example the signs of the MVx and MVy may be predicted jointly. More precisely, there are 4 possible combinations for the MVx and MVy signs: (+,+), (+,−), (−,+), (−,−). After prediction no extra information may be coded.
   f. In one example, the possible combinations may depend on whether MVx and/or MVy is equal to zero.
   g. In one example the signs of the MVx and MVy may be predicted (reorders), and one flag is coded to determine if the first option chosen or the second. This flag may be context coded or bypass coded.
   h. In one example the signs of the MVx and MVy may be predicted (reordered), and the top N (e.g. N=2,3, . . . ) options may be signaled with an index which is coded with a non-fixed length code (e.g. Unary or Truncated Unary code, or Binary code). The index may be context coded or bypass coded.
      i. In one example, if a first option is before a second option after reordering, the code length of the first option should be no longer than that of the second option.
   i. In one example, the sign of MVx and/or MVy may be coded with a context coding, wherein the context may be determined by a prediction of MVx and/or MVy.
   j. In one example, the sign of MVx and/or MVy may be coded with a context coding, wherein the context may be dependent on the magnitude of the MVD component.
   k. In one example, the information indicating whether a prediction is correct or not for a MVx and/or a MVy may be signaled conditionally.
      i. In one example, the information may not be signaled if the MVx and/or the MVy is equal to zero.
   l. In one example, the sign of MVx and/or MVy may not be signaled explicitly, but set equal to the prediction value implicitly.
10. The sign prediction (or reordering) of MVD may be based on a template matching approach or bilateral matching approach.
   a. In one example, the reorder criteria for the candidates may be template matching cost between a template around the current block and the reference for that template.
      i. In one example this cost may be Sum of Absolute Difference (SAD) between the template samples and their references.
      ii. In one example this cost may be Sum of Absolute Transformed Difference (SATD) or any other cost measure between the template samples and their references.
      iii. In one example this cost may be Mean Removal based Sum of Absolute Difference (MR-SAD) between the template samples and their references.
      iv. In one example this cost may be a weighted average of SAD/MR-SAD and SATD between the template samples and their references.
      v. In one example, the cost function between current template and reference template may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.
   b. In one example, build MV candidates by creating combination between possible signs and absolute MVD value and add it to the MV predictor. Derive MVD sign prediction cost for each derived MV candidate based on template matching cost or bilateral matching cost and sort the MVD signs ascendingly according to cost values.
      i. In one example, the true MVD sign used finally may be the MVD sign with the smallest MVD sign prediction cost.
      ii. In one example, the true MVD sign used finally may be selected among the first N (e.g. N=2,3, . . . ) MVD signs in the sorted MVD sign list.
         (i) In one example, the selected MVD sign (i.e. the true MVD sign used finally) may be signaled with a flag or an index. And the flag or index may be context coded or bypass coded.

### On Combination of MVD Sign Prediction and MMVD Reordering

11. It is proposed that any of MVD sign prediction for AMVP mode and/or its extensions (e.g., affine AMVP), MMVD mode and/or its extensions may be combined with any MMVD reordering for MMVD mode and/or extensions of MMVD (e.g., the affine MMVD or GPM MMVD (GMVD), MMVD for IBC mode, MMVD for affine IBC mode).
   a. In one example any MVD sign prediction for AMVP may be combined with any MMVD reordering for MMVD.
   b. In one example any MVD sign prediction for affine AMVP may be combined with any MMVD reordering for affine MMVD.
   c. In one example any MVD sign prediction for AMVP and affine AMVP may be combined with any MMVD reordering for MMVD and affine MMVD.
   d. In one example any MVD sign prediction for AMVP and affine AMVP and affine MMVD, may be combined with any MMVD reordering for MMVD.
   e. In one example any MVD sign prediction for AMVP and affine AMVP and MMVD, may be combined with any MMVD reordering for affine MMVD or its other extensions.
   f. In one example both sign prediction and MMVD reordering, may be applied on MV simultaneously. For example, sign prediction would be applied on MMVD sign, and MMVD reordering may be applied on MMVD magnitude or its base.
   g. In one example, sign prediction may be applied to MVD coding methods excluding MMVD (such as AMVP), but MMVD reordering may be applied to MMVD mode.

### On MMVD for Bi-Prediction Base Candidate

Denote the MVD candidate list of list X (e.g., X=0) as {MvdLXᵢ} wherein i is in the range of [0, M−1] and M is the total number of allowed MVD candidates for list X. The MVD candidate list of list Y (e.g., Y=1−x) as {MvdLYⱼ} wherein j is in the range of [0, N−1] and N is the total number of allowed MVD candidates for list Y.
12. Instead of always signaling the MVD information for list 0, it is proposed to signal the MVD information for list 1.
   a. Alternatively, whether to signal it for list 0 or list 1 may be further indicated in the bitstream or determined on-the-fly (e.g., according to the reference picture information of the base candidate).
13. It is proposed that N and M may be unequal.
   a. In one example, N and/or M may be pre-defined or determined on-the-fly or signalled.
14. It is proposed that the MMVD for bi-prediction may be modified to:
   b. In one example List 0 and list 1 having their own independent MVD wherein the MvdLYⱼ is not derived from the MvdLXⱼ using the prior art.
   c. In one example only List 0 has MVD and List 1 has no MVD (0).
   d. In one example only List 1 has MVD and List 0 has no MVD(0).
   e. In one example only the reference picture with closest distance to current picture may have MMVD, and the other one has no MVD (0).
   f. In one example only the reference picture with further distance to current picture may have MMVD, and the other one has no MVD (0).
   g. In one example, only the reference direction (List 0 or List 1) whose MV has larger cost may have MVD.
      i. In one example, only the reference direction (List 0 or List 1) whose MV has smaller cost may have MVD.
      ii. In one example, the cost may be the template matching cost corresponding to the MV of one reference list (List 0 or List 1).
      iii. In one example, the cost may be the bilateral matching cost corresponding to the MV of one reference list (List 0 or List 1).
   h. In one example only the reference ahead of the current picture may have MVD.
   i. In one example only the reference after the current picture may have MVD.
   j. In one example depending on the reference block's MV size or angle, only one may have MVD.
   k. In one example bi-prediction candidates may be converted to a uni candidate and MVD may apply on it.
   l. In one example, among both List 0 and List 1 have MVD, only List 0 has MVD, only List 1 has MVD, which one is finally used may be determined by RD decision and signaled to the decoder.
15. It is proposed to the final MVDs of list 0 and list 1 may be (MvdLXᵢ, MvdLYⱼ) pairs wherein i is unequal to j.
   m. In one example, for all (MvdLXᵢ, MvdLYⱼ) pairs with i being equal or unequal to j, the template costs may be calculated. and the pair which gives the smallest template cost may be selected as the final MVDs for list 0 and list 1.
      i. Alternatively, furthermore, early termination may be applied to reduce number of pairs to be checked.
16. It is proposed to determine the final MVD of list 0 and list 1 separately.
   n. In one example, instead of calculating the template cost based on the (MvdLXⱼ, MvdLYⱼ) pair, the template cost may be calculated for each candidate in list 0 and list 1 independently.
      i. Alternatively, furthermore, the MvdLXⱼ with the smallest template cost may be used as the final MVD for list X.
17. It is proposed to add zero MVD to the MVD candidate list in MMVD design.

### On Template Reference Samples

18. It is proposed that a first interpolation filter used to generate the template reference samples for MMVD reordering and/or MVD sign prediction may be different from a second interpolation filter used to generate the reference samples for inter-prediction.
   o. For example, the first interpolation filter may have less taps that the second interpolation filter.
   p. For example, the first interpolation filter may be a bi-linear filter or a 4-tap filter.
   q. In one example 12-tap interpolation filter may be used.
19. It is proposed that a first interpolation filter used to generate the template reference samples for MMVD reordering and/or MVD sign prediction may be different from a second interpolation filter used to generate the r template reference samples for another coding tool, e.g., TM-based merge candidate list.
20. It is proposed a modified MV (e.g., an estimation for MV magnitude) may be used for MVD sign prediction or MMVD reordering.
   r. In one example nearest integer estimation may be used for prediction/reordering.
   s. In one example nearest half pxl estimation may be used for prediction/reordering
   t. In one example nearest 4-pxl estimation may be used for prediction/reordering

### On Extension of Number of the Base Candidates Used in MMVD

21. It is proposed that at least one extra base candidate could be added to the original base candidates for MMVD and/or its extensions (e.g., affine MMVD).
   a. Alternatively, at least one existing base candidate could be removed from the original base candidates for MMVD and/or its extensions (e.g., affine MMVD).
   b. In one example depending on the block size, additional base candidates may be added.
   c. In one example depending on the picture resolution, additional base candidates may be added.
   d. In one example depending on the similarity/difference between the original base candidates, additional ones may be added.
   e. Alternatively, depending on the block size and/or the picture resolution and/or the similarity/difference between the original base candidates, at least one existing base candidate may be removed from the original base candidates.
   f. The base candidate index may be coded with truncated unary code, or truncated binary code, or Rice code of parameter R or Exponential Golomb code of order k, with any combination of bypass and context coded bin.
      i. Alternatively, it may be combined with the offset index and be coded jointly.
22. Whether to and/or how to apply the methods described above may be dependent on coded information.
   g. In one example, the coded information may include block sizes and/or temporal layers, and/or slice/picture types, colour component, et al.
23. Whether to and/or how to apply the methods described above may be indicated in the bitstream.
   h. The indication of enabling/disabling or which method to be applied may be signalled at sequence level/group of pictures level/picture level/slice level/tile group level, such as in sequence header/picture header/SPS/VPS/DPS/DCI/PPS/APS/slice header/tile group header.
   i. The indication of enabling/disabling or which method to be applied may be signaled at PB/TB/CB/PU/TU/CU/VPDU/CTU/CTU row/slice/tile/sub-picture/other kinds of region contain more than one sample or pixel.

The embodiments of the present disclosure are related to motion vector difference sign prediction and extended MMVD reordering. As used herein, the term “MMVD” may refer to a coding tool where partial of motion information (e.g., reference picture index, prediction direction from List 0/1, and base motion vectors) is inherited from a candidate while indication of some additional refinement of refined motion information (e.g., refined mv differences) is further signaled in the bitstream. MMVD may also comprise extensions of MMVD, e.g., the affine MMVD or GPM MMVD (GMVD), MMVD for IBC mode, MMVD for affine IBC mode. The term “sign prediction” is also referred to as “sign reordering”. The term “block” may represent a coding tree block (CTB), a coding tree unit (CTU), a coding block (CB), a coding unit (CU), a prediction unit (PU), a transform unit (TU), a prediction block (PB), a transform block (TB), a video processing unit comprising multiple samples/pixels, and/or the like. A block may be rectangular or non-rectangular.

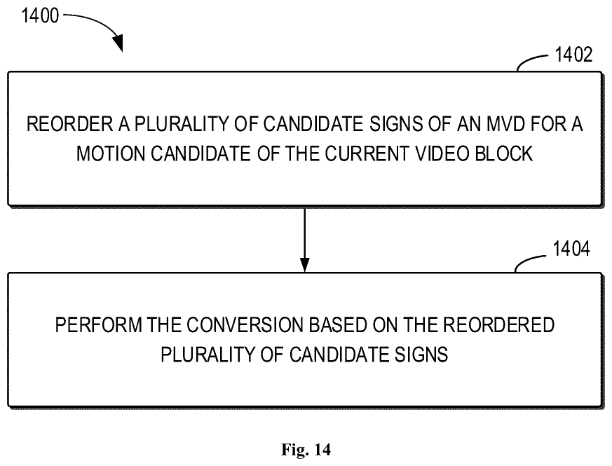

FIG. 14 illustrates a flowchart of a method 1400 for video processing in accordance with some embodiments of the present disclosure. The method 1400 may be implemented during a conversion between a current video block of a video and a bitstream of the video. As shown in FIG. 14, the method 1400 starts at 1402 where a plurality of candidate signs of an MVD for a motion candidate of the current video block are reordered. By way of example, the plurality of candidate signs may comprise candidate signs of a horizontal component of the MVD (also denoted as MVx hereinafter). The plurality of candidate signs may be reordered based on a template matching cost.

At 1404, the conversion is performed based on the reordered plurality of candidate signs. By way of example, a candidate sign at the first position in the reordered plurality of candidate signs may be used for performing the conversion. In one example, the conversion may include encoding the current chroma block into the bitstream. Alternatively or additionally, the conversion may include decoding the current chroma block from the bitstream. It should be understood that the above examples are described merely for purpose of description. The scope of the present disclosure is not limited in this respect.

According to the method 1400, the candidate signs of MVD are reordered. Compared with the conventional solution where such reordering process is not utilized, the proposed method can advantageously improve coding efficiency and coding quality.

In some embodiments, the MVD may be determined based on various coding tools. Examples of such coding tools may comprise advanced motion vector prediction (AMVP), affine AMVP, MMVD, affine MMVD, geometry partition mode with MMVD (GMVD), MMVD for intra block copy (IBC) mode, MMVD for affine IBC mode, and/or the like. It should be understood that the above examples are described merely for purpose of description. The scope of the present disclosure is not limited in this respect.

In some embodiments, the plurality of candidate signs may comprise candidate signs of a horizontal component of the MVD. In some alternative or additional embodiments, the plurality of candidate signs may comprise candidate signs of a vertical component of the MVD (also denoted as MVy hereinafter).

In some embodiments, an indication may be coded. The indication indicates whether a candidate sign at the first position in the reordered plurality of candidate signs is to be used. In one example, the indication may be a flag. That is, one flag is coded to determine whether the prediction is correct or not.

In some embodiments, the plurality of candidate signs may comprise a plurality of sign combinations. Each of the plurality of sign combinations may comprises a candidate sign of a horizontal component of the MVD and a candidate sign of a vertical component of the MVD. By way of example, four possible combinations are (+,+), (+,−), (−,+), and (−,−). It should be understood that the above examples are described merely for purpose of description. The scope of the present disclosure is not limited in this respect.

In some embodiments, the plurality of sign combinations may be dependent on information on whether the horizontal component of the MVD is equal to zero, and/or information on whether the vertical component of the MVD is equal to zero.

In some embodiments, an indication may be coded. The indication indicates whether a sign combination at the first position or the second position in the reordered plurality of candidate signs is to be used. That is, one indication may be coded to determine if the first option or the second option in the reordered list is chosen. In some embodiments, the indication may be a flag, and the flag may be context coded or bypass coded.

In some embodiments, a set of sign combinations at the top N positions in the reordered plurality of candidate signs may be indicated in the bitstream with a set of indexes. N is an integer. The set of indexes may be coded with a non-fixed length code, such as unary code, truncated unary code, or binary code. Alternatively, the set of indexes may be context coded or bypass coded.

In some embodiments, a code length of a first sign combination may be shorter than or equal to a code length of a second sign combination. The first sign combination is in front of the second sign combination in the reordered plurality of candidate signs.

In some embodiments, at least one of the following may be coded with a context coding: a candidate sign of the horizontal component of the MVD, or a candidate sign of the vertical component of the MVD. In one example, a context for the context coding may be determined based on at least one of a prediction of the horizontal component of the MVD or a prediction of the vertical component of the MVD. Alternatively or additionally, a context for the context coding may be determined based on at least one of a magnitude of the horizontal component of the MVD or a magnitude of the vertical component of the MVD.

In some embodiments, whether first information is indicated in the bitstream may be dependent on a condition. The first information indicates whether a candidate sign at the first position in the reordered plurality of candidate signs is to be used. In one example, the first information may be absent from the bitstream, if the horizontal component of the MVD and/or the vertical component of the MVD is equal to zero.

In some embodiments, a candidate sign at the first position in the reordered plurality of candidate signs may be used for performing the conversion. That is, there won't be any signaling to indicate if the prediction was correct or not. The sign of MVx and/or MVy is always set to the prediction.

In some embodiments, at 1402, the plurality of candidate signs may be reordered based on a template matching approach. Alternatively, the plurality of candidate signs may be reordered based on a bilateral matching approach. It should be understood that the above illustrations are described merely for purpose of description. The scope of the present disclosure is not limited in this respect.

In some embodiments, at 1402, the plurality of candidate signs may be reordered based on a template matching cost between a current template associated with the current video block and a reference template for the current template. In one example, the template matching cost may be determined as a sum of absolute difference (SAD) between the current template and the reference template. Alternatively, the template matching cost may be determined as a sum of absolute transformed difference (SATD) between the current template and the reference template. In another example, the template matching cost may be determined as a mean removal based sum of absolute difference (MR-SAD) between the current template and the reference template. In some further examples, the template matching cost may be determined as one of: a weighted average of SAD between the current template and the reference template, a weighted average of MR-SAD between the current template and the reference template, or a weighted average of SATD between the current template and the reference template.

In some embodiments, a cost function for determining the template matching cost may comprises one of: SAD, MR-SAD, SATD, mean-removal SATD (MR-SATD), sum of squared differences (SSD), mean-removal SSD (MR-SSD), sum of squared error (SSE), mean removal sum of squared error (MR-SSE) weighted SAD, weighted MR-SAD, weighted SATD, weighted MR-SATD, weighted SSD, weighted MR-SSD, weighted SSE, weighted MR-SSE, or gradient information. It should be understood that the above examples are described merely for purpose of description. The scope of the present disclosure is not limited in this respect.

In some embodiments, at 1402, prediction costs for the plurality of candidate signs may be determined based on a template matching cost or a bilateral matching cost. The plurality of candidate signs may be reordered ascendingly based on the prediction costs.

In some embodiments, at 1404, a candidate MVD may be obtained by combining a candidate sign in the reordered plurality of candidate signs with an absolute MVD value. A candidate MV may be obtained by adding the candidate MVD to a predicted MV. The conversion may be performed based on the candidate MV.

In some embodiments, a target sign used for performing the conversion may be a candidate sign with the smallest prediction cost in the reordered plurality of candidate signs. In some alternative embodiments, a target sign used for performing the conversion may be selected from a set of candidate signs at the top N positions in the reordered plurality of candidate signs. N is an integer. In some additional embodiments, an indication of the target sign may be indicated in the bitstream. In one example, the indication may be an index or a flag. For example, the indication may be context coded or bypass coded.

In some embodiments, at 1404, the conversion may be performed based on the reordered plurality of candidate signs and an MMVD reordering process. That is, any of MVD sign prediction for AMVP mode and/or its extensions (e.g., affine AMVP), MMVD mode and/or its extensions may be combined with any MMVD reordering for MMVD mode and/or extensions of MMVD (e.g., the affine MMVD or GPM MMVD (GMVD), MMVD for IBC mode, MMVD for affine IBC mode).

In some embodiments, the MVD may be determined based on AMVP, and the conversion may be performed based on the reordered plurality of candidate signs and an MMVD reordering process for MMVD. That is, any MVD sign prediction for AMVP may be combined with any MMVD reordering for MMVD.

In some embodiments, the MVD may be determined based on affine AMVP, and the conversion may be performed based on the reordered plurality of candidate signs and an MMVD reordering process for affine MMVD. That is, any MVD sign prediction for affine AMVP may be combined with any MMVD reordering for affine MMVD.

In some embodiments, the MVD may be determined based on AMVP and affine AMVP, and the conversion may be performed based on the reordered plurality of candidate signs and an MMVD reordering process for MMVD and affine MMVD. That is, any MVD sign prediction for AMVP and affine AMVP may be combined with any MMVD reordering for MMVD and affine MMVD.

In some embodiments, the MVD may be determined based on AMVP, affine AMVP and affine MMVD, and the conversion may be performed based on the reordered plurality of candidate signs and an MMVD reordering process for MMVD. That is, any MVD sign prediction for AMVP and affine AMVP and affine MMVD, may be combined with any MMVD reordering for MMVD.

In some embodiments, the MVD may be determined based on AMVP, affine AMVP and MMVD, and the conversion may be performed based on the reordered plurality of candidate signs and an MMVD reordering process for affine MMVD. That is, any MVD sign prediction for AMVP and affine AMVP and MMVD, may be combined with any MMVD reordering for affine MMVD or its other extensions.

In some embodiments, the MVD may be determined based on a first coding tool, and the conversion may be performed based on the reordered plurality of candidate signs and an MMVD reordering process for the first coding tool. That is, both sign prediction and MMVD reordering, may be applied on MV simultaneously. In some example, the first coding tool may be MMVD. For example, sign prediction would be applied on MMVD sign, and MMVD reordering may be applied on MMVD magnitude or its base.

In some embodiments, the MVD may be determined based on an MVD coding tool other than MMVD, and the conversion may be performed based on the reordered plurality of candidate signs and an MMVD reordering process for MMVD. That is, sign prediction may be applied to MVD coding methods excluding MMVD (such as AMVP), but MMVD reordering may be applied to MMVD mode.

In some embodiments, a first interpolation filter for generating reference samples of the current template may be different from a second interpolation filter for generating reference samples for inter-prediction of the current video block.

In some embodiments, the number of taps of the first interpolation filter may be less than the second interpolation filter. For example, the first interpolation filter may be one of: a bi-linear filter, a 4-tap filter, or a 12-tap interpolation filter. It should be understood that the above examples are described merely for purpose of description. The scope of the present disclosure is not limited in this respect. In some alternative embodiments, a first interpolation filter for generating reference samples of the current template may be different from a second interpolation filter for generating template reference samples for a further coding tool.

In some embodiments, a magnitude of the motion candidate may be adapted to a predetermined resolution. That is, a modified MV (e.g., an estimation for MV magnitude) may be used for MVD sign prediction or MMVD reordering. In one example, the magnitude of the motion candidate may be rounded to the nearest integer pixel. That is, the nearest integer estimation may be used. In another example, the magnitude of the motion candidate may be rounded to the nearest half pixel. That is, the nearest half pixel estimation may be used. In yet another example, the magnitude of the motion candidate may be rounded to the nearest 4 pixel. That is, the nearest 4-pxl estimation may be used. It should be understood that the above examples are described merely for purpose of description. The scope of the present disclosure is not limited in this respect.

In some embodiments, a bitstream of a video may be stored in a non-transitory computer-readable recording medium. The bitstream of the video can be generated by a method performed by a video processing apparatus. According to the method, a plurality of candidate signs of an MVD for a motion candidate of the current video block are reordered. Moreover, the bitstream may be generated based on the reordered plurality of candidate signs.

In some embodiments, a plurality of candidate signs of an MVD for a motion candidate of the current video block are reordered. Moreover, the bitstream may be generated based on the reordered plurality of candidate signs. The bitstream may be stored in a non-transitory computer-readable recording medium.

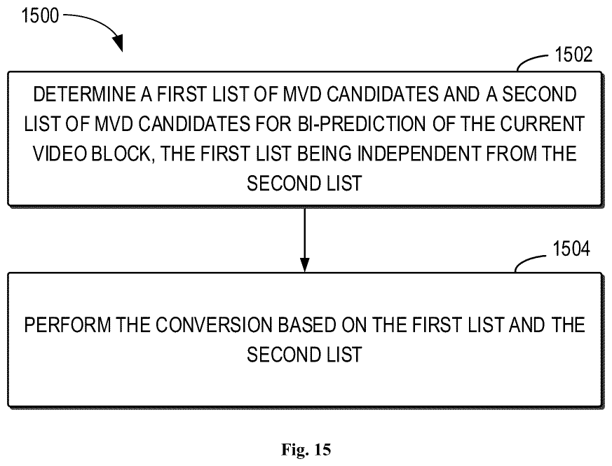

FIG. 15 illustrates a flowchart of a method 1500 for video processing in accordance with some embodiments of the present disclosure. The method 1500 may be implemented during a conversion between a current chroma block of a video and a bitstream of the video. As shown in FIG. 15, the method 1500 starts at 1502 where a first list of MVD candidates and a second list of MVD candidates are determined for bi-prediction of the current video block. The first list is independent from the second list. By way of example, the first list and the second list may be determined separately, and the number of MVD candidates in the first list may be different from the number of MVD candidates in the second list. It should be understood that the above examples are described merely for purpose of description. The scope of the present disclosure is not limited in this respect.

At 1504, the conversion is performed based on the first list and the second list. By way of example, an MVD pair comprising a first MVD candidate from the first list and a second MVD candidate from the second list may be used for performing the conversion. In one example, the conversion may include encoding the current chroma block into the bitstream. Alternatively or additionally, the conversion may include decoding the current chroma block from the bitstream.

According to the method 1500, the two MVD candidate lists for bi-prediction are independent from each other. Compared with the conventional solution where two MVD candidate lists for bi-prediction are correlated, the proposed method can advantageously improve coding efficiency and coding quality.

In some embodiments, the first list or the second list may be indicated in the bitstream. In one example, information on whether the first list or the second list is indicated in the bitstream may be indicated in the bitstream. In another example, information on whether the first list or the second list is indicated in the bitstream may be determined on-the-fly. For example, information on whether the first list or the second list is indicated in the bitstream is determined based on reference picture information of a based candidate for the current video block.

In some embodiments, the number of MVD candidates in the first list may be different from the number of MVD candidates in the second list. In one example, the number of MVD candidates in the first list and the number of MVD candidates in the second list may be predefined. In another example, the number of MVD candidates in the first list and the number of MVD candidates in the second list may be determined on-the-fly. In yet another example, the number of MVD candidates in the first list and the number of MVD candidates in the second list may be indicated in the bitstream.

In some embodiments, MVD candidates in the first list may be independent from MVD candidates in the second list. In some alternative or additional embodiments, the number of MVD candidates in the first list may be non-zero and the number of MVD candidates in the second list may be zero. Alternatively, the number of MVD candidates in the first list may be zero and the number of MVD candidates in the second list may be non-zero.

In some embodiments, the first list may be associated with a first reference block for the current block. The second list may be associated with a second reference block for the current block. A distance between the first reference block and the current block may be smaller than a distance between the second reference block and the current block. The number of MVD candidates in the first list may be non-zero and the number of MVD candidates in the second list may be zero. That is, only the reference picture with closest distance to current picture may have MVD, and the other one has no MVD.

In some embodiments, the first list may be associated with a first reference block for the current block. The second list may be associated with a second reference block for the current block. A distance between the first reference block and the current block may be larger than a distance between the second reference block and the current block. The number of MVD candidates in the first list may be non-zero and the number of MVD candidates in the second list may be zero. That is, only the reference picture with further distance to current picture may have MMVD, and the other one has no MVD.

In some embodiments, the first list may be associated with a first reference direction for the current block. The second list may be associated with a second reference direction for the current block. A cost of a first MV of the first direction may be larger than a cost of a second MV of the second direction. The number of MVD candidates in the first list may be non-zero and the number of MVD candidates in the second list may be zero. That is, only the reference direction (List 0 or List 1) whose MV has larger cost may have MVD.

In some embodiments, the first list may be associated with a first reference direction for the current block. The second list may be associated with a second reference direction for the current block. A cost of a first MV of the first direction may be smaller than a cost of a second MV of the second direction. The number of MVD candidates in the first list may be non-zero and the number of MVD candidates in the second list may be zero. That is, only the reference direction (List 0 or List 1) whose MV has smaller cost may have MVD.

In some embodiments, the cost of the first MV may be a template matching cost of the first MV. That is, the cost may be the template matching cost corresponding to the MV of one reference list (List 0 or List 1). In some alternative embodiments, the cost of the first MV may be a bilateral matching cost of the first MV. That is, the cost may be the bilateral matching cost corresponding to the MV of one reference list (List 0 or List 1).

In some embodiments, the first list may be associated with a first reference block for the current block. The second list may be associated with a second reference block for the current block. The first reference block may be ahead of the current block, and the second block may be after the current block. The number of MVD candidates in the first list may be non-zero and the number of MVD candidates in the second list may be zero. That is, only the reference ahead of the current picture may have MVD.

In some embodiments, the first list may be associated with a first reference block for the current block. The second list may be associated with a second reference block for the current block. The first reference block may be after the current block and the second block may be ahead of the current block. The number of MVD candidates in the first list may be non-zero and the number of MVD candidates in the second list may be zero. That is, only the reference after the current picture may have MVD.

In some embodiments, the first list may be associated with a first reference block for the current block. The second list may be associated with a second reference block for the current block. Whether the first list or the second list is empty may be dependent on a size or an angle of a MV for the first reference block and a size or an angle of a MV for the second reference block. That is, depending on the reference block's MV size or angle, only one list may have MVD.

In some embodiments, at least one of the first list or the second list may be converted to MVD candidates for uni-prediction of the current video block. In some embodiments, information on whether the first list or the second list is empty may be determined based on a rate-distortion (RD) and the information may be indicated in the bitstream.

In some embodiments, a target MVD pair for performing the conversion may comprises a first MVD candidate from the first list and a second MVD candidate from the second list. A position of the first MVD candidate in the first list may be different from a position of the second MVD candidate in the second list.

In some embodiments, at 1504, template costs for a plurality of MVD pairs may be determined based on the first list and the second list. The conversion may be performed based on a target MVD pair with the smallest template cost. In some embodiments, template costs may be determined for part of the plurality of MVD pairs. That is, early termination may be applied to reduce the number of MVD pairs to be checked.

In some embodiments, each MVD in a target MVD pair for performing the conversion may be determined separately. In one example, a template cost may be determined for each of MVD candidates in the first list and the second list. By way of example, a first MVD candidate with the smallest template cost in the first list and a second MVD candidate with the smallest template cost in the second list may be used for performing the conversion.

In some embodiments, a zero MVD may be added in to the first list or the second list for MMVD.

In some embodiments, a bitstream of a video may be stored in a non-transitory computer-readable recording medium. The bitstream of the video can be generated by a method performed by a video processing apparatus. According to the method, a first list of MVD candidates and a second list of MVD candidates are determined for bi-prediction of the current video block. The first list is independent from the second list. Moreover, the bitstream may be generated based on the first list and the second list.

In some embodiments, a first list of MVD candidates and a second list of MVD candidates are determined for bi-prediction of the current video block. The first list is independent from the second list. Moreover, the bitstream may be generated based on the first list and the second list. The bitstream may be stored in a non-transitory computer-readable recording medium.

Implementations of the present disclosure can be described in view of the following clauses, the features of which can be combined in any reasonable manner.

Clause 1. A method for video processing, comprising: reordering, during a conversion between a current video block of a video and a bitstream of the video, a plurality of candidate signs of a motion vector difference (MVD) for a motion candidate of the current video block; and performing the conversion based on the reordered plurality of candidate signs.

Clause 2. The method of clause 1, wherein the MVD is determined based on one of: advanced motion vector prediction (AMVP), affine AMVP, merge mode with motion vector differences (MMVD), affine MMVD, geometry partition mode with MMVD (GMVD), MMVD for intra block copy (IBC) mode, or MMVD for affine IBC mode.

Clause 3. The method of any of clauses 1-2, wherein the plurality of candidate signs comprise candidate signs of a horizontal component of the MVD.

Clause 4. The method of any of clauses 1-3, wherein the plurality of candidate signs comprise candidate signs of a vertical component of the MVD.

Clause 5. The method of any of clauses 3-4, wherein an indication is coded, the indication indicates whether a candidate sign at the first position in the reordered plurality of candidate signs is to be used.

Clause 6. The method of clause 5, wherein the indication is a flag.

Clause 7. The method of any of clauses 1-2, wherein the plurality of candidate signs comprise a plurality of sign combinations, each of the plurality of sign combinations comprises a candidate sign of a horizontal component of the MVD and a candidate sign of a vertical component of the MVD.

Clause 8. The method of clause 7, wherein the plurality of sign combinations are dependent on at least one of: information on whether the horizontal component of the MVD is equal to zero, or information on whether the vertical component of the MVD is equal to zero.

Clause 9. The method of any of clauses 7-8, wherein an indication is coded, the indication indicates whether a sign combination at the first position or the second position in the reordered plurality of candidate signs is to be used.

Clause 10. The method of clause 9, wherein the indication is a flag, and the flag is context coded or bypass coded.

Clause 11. The method of any of clauses 7-8, wherein a set of sign combinations at the top N positions in the reordered plurality of candidate signs are indicated in the bitstream with a set of indexes, the set of indexes are coded with a non-fixed length code, where N is an integer.

Clause 12. The method of clause 11, wherein the set of indexes are context coded or bypass coded.

Clause 13. The method of any of clauses 11-12, wherein a code length of a first sign combination is shorter than or equal to a code length of a second sign combination, the first sign combination is in front of the second sign combination in the reordered plurality of candidate signs.

Clause 14. The method of any of clauses 3-4, wherein at least one of the following is coded with a context coding: a candidate sign of the horizontal component of the MVD, or a candidate sign of the vertical component of the MVD.

Clause 15. The method of clause 14, wherein a context for the context coding is determined based on at least one of a prediction of the horizontal component of the MVD or a prediction of the vertical component of the MVD.

Clause 16. The method of clause 14, wherein a context for the context coding is determined based on at least one of a magnitude of the horizontal component of the MVD or a magnitude of the vertical component of the MVD.

Clause 17. The method of any of clauses 3-4, wherein whether first information is indicated in the bitstream is dependent on a condition, the first information indicates whether a candidate sign at the first position in the reordered plurality of candidate signs is to be used.

Clause 18. The method of clause 17, wherein the first information is absent from the bitstream, if the horizontal component of the MVD and/or the vertical component of the MVD is equal to zero.

Clause 19. The method of any of clauses 3-4, wherein a candidate sign at the first position in the reordered plurality of candidate signs is used for performing the conversion.

Clause 20. The method of any of clauses 1-19, wherein reordering the plurality of candidate signs comprises: reordering the plurality of candidate signs based on a template matching approach, or reordering the plurality of candidate signs based on a bilateral matching approach.

Clause 21. The method of clause 20, wherein reordering the plurality of candidate signs based on a template matching approach comprises: reordering the plurality of candidate signs based on a template matching cost between a current template associated with the current video block and a reference template for the current template.

Clause 22. The method of clause 21, wherein the template matching cost is determined as a sum of absolute difference (SAD) between the current template and the reference template.

Clause 23. The method of clause 21, wherein the template matching cost is determined as a sum of absolute transformed difference (SATD) between the current template and the reference template.

Clause 24. The method of clause 21, wherein the template matching cost is determined as a mean removal based sum of absolute difference (MR-SAD) between the current template and the reference template.

Clause 25. The method of clause 21, wherein the template matching cost is determined as one of: a weighted average of SAD between the current template and the reference template, a weighted average of MR-SAD between the current template and the reference template, or a weighted average of SATD between the current template and the reference template.

Clause 26. The method of clause 21, wherein a cost function for determining the template matching cost comprises one of: SAD, MR-SAD, SATD, mean-removal SATD (MR-SATD), sum of squared differences (SSD), mean-removal SSD (MR-SSD), sum of squared error (SSE), mean removal sum of squared error (MR-SSE) weighted SAD, weighted MR-SAD, weighted SATD, weighted MR-SATD, weighted SSD, weighted MR-SSD, weighted SSE, weighted MR-SSE, or gradient information.

Clause 27. The method of any of clauses 1-19, wherein reordering the plurality of candidate signs comprises: determining prediction costs for the plurality of candidate signs based on a template matching cost or a bilateral matching cost; and reordering the plurality of candidate signs ascendingly based on the prediction costs.

Clause 28. The method of clause 27, wherein performing the conversion comprises: obtaining a candidate MVD by combining a candidate sign in the reordered plurality of candidate signs with an absolute MVD value; obtaining a candidate MV by adding the candidate MVD to a predicted MV; and performing the conversion based on the candidate MV.

Clause 29. The method of any of clauses 27-28, wherein a target sign used for performing the conversion is a candidate sign with the smallest prediction cost in the reordered plurality of candidate signs.

Clause 30. The method of any of clauses 27-28, wherein a target sign used for performing the conversion is selected from a set of candidate signs at the top N positions in the reordered plurality of candidate signs, where N is an integer.

Clause 31. The method of clause 30, wherein an indication of the target sign is indicated in the bitstream.

Clause 32. The method of clause 31, wherein the indication is an index or a flag.

Clause 33. The method of any of clauses 31-32, wherein the indication is context coded or bypass coded.

Clause 34. The method of any of clauses 1-33, wherein performing the conversion comprises: performing the conversion based on the reordered plurality of candidate signs and an MMVD reordering process.

Clause 35. The method of clause 1, wherein the MVD is determined based on AMVP, and performing the conversion comprises: performing the conversion based on the reordered plurality of candidate signs and an MMVD reordering process for MMVD.

Clause 36. The method of clause 1, wherein the MVD is determined based on affine AMVP, and performing the conversion comprises: performing the conversion based on the reordered plurality of candidate signs and an MMVD reordering process for affine MMVD.

Clause 37. The method of clause 1, wherein the MVD is determined based on AMVP and affine AMVP, and performing the conversion comprises: performing the conversion based on the reordered plurality of candidate signs and an MMVD reordering process for MMVD and affine MMVD.

Clause 38. The method of clause 1, wherein the MVD is determined based on AMVP, affine AMVP and affine MMVD, and performing the conversion comprises: performing the conversion based on the reordered plurality of candidate signs and an MMVD reordering process for MMVD.

Clause 39. The method of clause 1, wherein the MVD is determined based on AMVP, affine AMVP and MMVD, and performing the conversion comprises: performing the conversion based on the reordered plurality of candidate signs and an MMVD reordering process for affine MMVD.

Clause 40. The method of clause 1, wherein the MVD is determined based on a first coding tool, and performing the conversion comprises: performing the conversion based on the reordered plurality of candidate signs and an MMVD reordering process for the first coding tool.

Clause 41. The method of clause 40, wherein the first coding tool is MMVD.

Clause 42. The method of clause 1, wherein the MVD is determined based on an MVD coding tool other than MMVD, and performing the conversion comprises: performing the conversion based on the reordered plurality of candidate signs and an MMVD reordering process for MMVD.

Clause 43. The method of clause 21, wherein a first interpolation filter for generating reference samples of the current template is different from a second interpolation filter for generating reference samples for inter-prediction of the current video block.

Clause 44. The method of clause 43, wherein the number of taps of the first interpolation filter is less than the second interpolation filter.

Clause 45. The method of any of clauses 43-44, wherein the first interpolation filter is one of: a bi-linear filter, a 4-tap filter, or a 12-tap interpolation filter.

Clause 46. The method of clause 21, wherein a first interpolation filter for generating reference samples of the current template is different from a second interpolation filter for generating template reference samples for a further coding tool.

Clause 47. The method of any of clauses 1-46, wherein a magnitude of the motion candidate is adapted to a predetermined resolution.

Clause 48. The method of clause 47, wherein the magnitude of the motion candidate is rounded to the nearest integer pixel.

Clause 49. The method of clause 47, wherein the magnitude of the motion candidate is rounded to the nearest half pixel.

Clause 50. The method of clause 47, wherein the magnitude of the motion candidate is rounded to the nearest 4 pixel.

Clause 51. A method for video processing, comprising: determining, during a conversion between a current video block of a video and a bitstream of the video, a first list of MVD candidates and a second list of MVD candidates for bi-prediction of the current video block, the first list being independent from the second list; and performing the conversion based on the first list and the second list.

Clause 52. The method of clause 51, wherein the first list or the second list is indicated in the bitstream.

Clause 53. The method of clause 52, wherein information on whether the first list or the second list is indicated in the bitstream is indicated in the bitstream, or information on whether the first list or the second list is indicated in the bitstream is determined on-the-fly.

Clause 54. The method of clause 52, wherein information on whether the first list or the second list is indicated in the bitstream is determined based on reference picture information of a based candidate for the current video block.

Clause 55. The method of any of clauses 51-54, wherein the number of MVD candidates in the first list is different from the number of MVD candidates in the second list.

Clause 56. The method of any of clauses 51-55, wherein the number of MVD candidates in the first list and the number of MVD candidates in the second list are predefined, the number of MVD candidates in the first list and the number of MVD candidates in the second list are determined on-the-fly, or the number of MVD candidates in the first list and the number of MVD candidates in the second list are indicated in the bitstream.

Clause 57. The method of any of clauses 51-56, wherein MVD candidates in the first list being independent from MVD candidates in the second list.

Clause 58. The method of any of clauses 51-56, wherein the number of MVD candidates in the first list is non-zero and the number of MVD candidates in the second list is zero.

Clause 59. The method of any of clauses 51-56, wherein the number of MVD candidates in the first list is zero and the number of MVD candidates in the second list is non-zero.

Clause 60. The method of any of clauses 51-56, wherein the first list is associated with a first reference block for the current block, the second list is associated with a second reference block for the current block, a distance between the first reference block and the current block is smaller than a distance between the second reference block and the current block, the number of MVD candidates in the first list is non-zero and the number of MVD candidates in the second list is zero.

Clause 61. The method of any of clauses 51-56, wherein the first list is associated with a first reference block for the current block, the second list is associated with a second reference block for the current block, a distance between the first reference block and the current block is larger than a distance between the second reference block and the current block, the number of MVD candidates in the first list is non-zero and the number of MVD candidates in the second list is zero.

Clause 62. The method of any of clauses 51-56, wherein the first list is associated with a first reference direction for the current block, the second list is associated with a second reference direction for the current block, a cost of a first MV of the first direction is larger than a cost of a second MV of the second direction, the number of MVD candidates in the first list is non-zero and the number of MVD candidates in the second list is zero.

Clause 63. The method of any of clauses 51-56, wherein the first list is associated with a first reference direction for the current block, the second list is associated with a second reference direction for the current block, a cost of a first MV of the first direction is smaller than a cost of a second MV of the second direction, the number of MVD candidates in the first list is non-zero and the number of MVD candidates in the second list is zero.

Clause 64. The method of any of clauses 62-63, wherein the cost of the first MV is a template matching cost of the first MV.

Clause 65. The method of any of clauses 62-63, wherein the cost of the first MV is a bilateral matching cost of the first MV.

Clause 66. The method of any of clauses 51-56, wherein the first list is associated with a first reference block for the current block, the second list is associated with a second reference block for the current block, the first reference block is ahead of the current block, the second block is after the current block, the number of MVD candidates in the first list is non-zero and the number of MVD candidates in the second list is zero.

Clause 67. The method of any of clauses 51-56, wherein the first list is associated with a first reference block for the current block, the second list is associated with a second reference block for the current block, the first reference block is after the current block, the second block is ahead of the current block, the number of MVD candidates in the first list is non-zero and the number of MVD candidates in the second list is zero.

Clause 68. The method of any of clauses 51-56, wherein the first list is associated with a first reference block for the current block, the second list is associated with a second reference block for the current block, whether the first list or the second list is empty is dependent on a size or an angle of a MV for the first reference block and a size or an angle of a MV for the second reference block.

Clause 69. The method of any of clauses 51-56, wherein at least one of the first list or the second list is converted to MVD candidates for uni-prediction of the current video block.

Clause 70. The method of any of clauses 51-56, wherein information on whether the first list or the second list is empty is determined based on a rate-distortion (RD) and the information is indicated in the bitstream.

Clause 71. The method of any of clauses 51-70, wherein a target MVD pair for performing the conversion comprises a first MVD candidate from the first list and a second MVD candidate from the second list, a position of the first MVD candidate in the first list is different from a position of the second MVD candidate in the second list.

Clause 72. The method of any of clauses 51-70, wherein performing the conversion comprises: determining template costs for a plurality of MVD pairs based on the first list and the second list; and performing the conversion based on a target MVD pair with the smallest template cost.

Clause 73. The method of clause 72, wherein template costs are determined for part of the plurality of MVD pairs.

Clause 74. The method of any of clauses 51-70, each MVD in a target MVD pair for performing the conversion is determined separately.

Clause 75. The method of clause 74, wherein a template cost is determined for each of MVD candidates in the first list and the second list.

Clause 76. The method of clause 75, wherein a first MVD candidate with the smallest template cost in the first list and a second MVD candidate with the smallest template cost in the second list are used for performing the conversion.

Clause 77. The method of any of clauses 51-76, wherein a zero MVD is added in to the first list or the second list for MMVD.

Clause 78. The method of any of clauses 1-77, wherein the conversion includes encoding the current video block into the bitstream.

Clause 79. The method of any of clauses 1-77, wherein the conversion includes decoding the current video block from the bitstream.

Clause 80. An apparatus for processing video data comprising a processor and a non-transitory memory with instructions thereon, wherein the instructions upon execution by the processor, cause the processor to perform a method in accordance with any of Clauses 1-79.

Clause 81. A non-transitory computer-readable storage medium storing instructions that cause a processor to perform a method in accordance with any of Clauses 1-79.

Clause 82. A non-transitory computer-readable recording medium storing a bitstream of a video which is generated by a method performed by a video processing apparatus, wherein the method comprises: reordering a plurality of candidate signs of a motion vector difference (MVD) for a motion candidate of a current video block of the video; and generating the bitstream based on the reordered plurality of candidate signs.

Clause 83. A method for storing a bitstream of a video, comprising: reordering a plurality of candidate signs of a motion vector difference (MVD) for a motion candidate of a current video block of the video; generating the bitstream based on the reordered plurality of candidate signs; and storing the bitstream in a non-transitory computer-readable recording medium.

Clause 84. A non-transitory computer-readable recording medium storing a bitstream of a video which is generated by a method performed by a video processing apparatus, wherein the method comprises: determining a first list of MVD candidates and a second list of MVD candidates for bi-prediction of a current video block of the video, the first list being independent from the second list; and generating the bitstream based on the first list and the second list.

Clause 85. A method for storing a bitstream of a video, comprising: determining a first list of MVD candidates and a second list of MVD candidates for bi-prediction of a current video block of the video, the first list being independent from the second list; generating the bitstream based on the first list and the second list; and storing the bitstream in a non-transitory computer-readable recording medium.

### Example Device

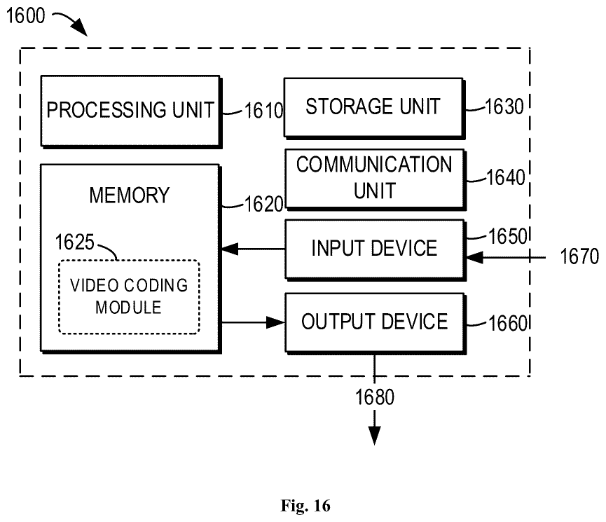

FIG. 16 illustrates a block diagram of a computing device 1600 in which various embodiments of the present disclosure can be implemented. The computing device 1600 may be implemented as or included in the source device 110 (or the video encoder 114 or 200) or the destination device 120 (or the video decoder 124 or 300).

It would be appreciated that the computing device 1600 shown in FIG. 16 is merely for purpose of illustration, without suggesting any limitation to the functions and scopes of the embodiments of the present disclosure in any manner.

As shown in FIG. 16, the computing device 1600 includes a general-purpose computing device 1600. The computing device 1600 may at least comprise one or more processors or processing units 1610, a memory 1620, a storage unit 1630, one or more communication units 1640, one or more input devices 1650, and one or more output devices 1660.

In some embodiments, the computing device 1600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1600 can support any type of interface to a user (such as “wearable” circuitry and the like).

The processing unit 1610 may be a physical or virtual processor and can implement various processes based on programs stored in the memory 1620. In a multi-processor system, multiple processing units execute computer executable instructions in parallel so as to improve the parallel processing capability of the computing device 1600. The processing unit 1610 may also be referred to as a central processing unit (CPU), a microprocessor, a controller or a microcontroller.

The computing device 1600 typically includes various computer storage medium. Such medium can be any medium accessible by the computing device 1600, including, but not limited to, volatile and non-volatile medium, or detachable and non-detachable medium. The memory 1620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1630 may be any detachable or non-detachable medium and may include a machine-readable medium such as a memory, flash memory drive, magnetic disk or another other media, which can be used for storing information and/or data and can be accessed in the computing device 1600.

The computing device 1600 may further include additional detachable/non-detachable, volatile/non-volatile memory medium. Although not shown in FIG. 16, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1640 communicates with a further computing device via the communication medium. In addition, the functions of the components in the computing device 1600 can be implemented by a single computing cluster or multiple computing machines that can communicate via communication connections. Therefore, the computing device 1600 can operate in a networked environment using a logical connection with one or more other servers, networked personal computers (PCs) or further general network nodes.

The input device 1650 may be one or more of a variety of input devices, such as a mouse, keyboard, tracking ball, voice-input device, and the like. The output device 1660 may be one or more of a variety of output devices, such as a display, loudspeaker, printer, and the like. By means of the communication unit 1640, the computing device 1600 can further communicate with one or more external devices (not shown) such as the storage devices and display device, with one or more devices enabling the user to interact with the computing device 1600, or any devices (such as a network card, a modem and the like) enabling the computing device 1600 to communicate with one or more other computing devices, if required. Such communication can be performed via input/output (I/O) interfaces (not shown).

In some embodiments, instead of being integrated in a single device, some or all components of the computing device 1600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1600 may be used to implement video encoding/decoding in embodiments of the present disclosure. The memory 1620 may include one or more video coding modules 1625 having one or more program instructions. These modules are accessible and executable by the processing unit 1610 to perform the functionalities of the various embodiments described herein.

In the example embodiments of performing video encoding, the input device 1650 may receive video data as an input 1670 to be encoded. The video data may be processed, for example, by the video coding module 1625, to generate an encoded bitstream. The encoded bitstream may be provided via the output device 1660 as an output 1680.

In the example embodiments of performing video decoding, the input device 1650 may receive an encoded bitstream as the input 1670. The encoded bitstream may be processed, for example, by the video coding module 1625, to generate decoded video data. The decoded video data may be provided via the output device 1660 as the output 1680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
reordering, during a conversion between a current video block of a video and a bitstream of the video, a plurality of candidate signs of a motion vector difference (MVD) for a motion candidate of the current video block; and
performing the conversion based on the reordered plurality of candidate signs.

2. The method of claim 1, wherein the MVD is determined based on one of:
advanced motion vector prediction (AMVP),
affine AMVP,
merge mode with motion vector differences (MMVD),
affine MMVD,
geometry partition mode with MMVD (GMVD),
MMVD for intra block copy (IBC) mode, or
MMVD for affine IBC mode.

3. The method of claim 1, wherein the plurality of candidate signs comprise candidate signs of a horizontal component of the MVD, or
wherein the plurality of candidate signs comprise candidate signs of a vertical component of the MVD, or
wherein the plurality of candidate signs comprise a plurality of sign combinations, each of the plurality of sign combinations comprises a candidate sign of a horizontal component of the MVD and a candidate sign of a vertical component of the MVD.

4. The method of claim 3, wherein the plurality of sign combinations are dependent on at least one of: information on whether the horizontal component of the MVD is equal to zero, or information on whether the vertical component of the MVD is equal to zero, or
wherein an indication is coded, the indication indicates whether a sign combination at the first position or the second position in the reordered plurality of candidate signs is to be used, or
wherein a set of sign combinations at the top N positions in the reordered plurality of candidate signs are indicated in the bitstream with a set of indexes, the set of indexes are coded with a non-fixed length code, where N is an integer, or
wherein at least one of the following is coded with a context coding: a candidate sign of the horizontal component of the MVD, or a candidate sign of the vertical component of the MVD, or
wherein whether first information is indicated in the bitstream is dependent on a condition, the first information indicates whether a candidate sign at the first position in the reordered plurality of candidate signs is to be used, or
wherein a candidate sign at the first position in the reordered plurality of candidate signs is used for performing the conversion.

5. The method of claim 1, wherein reordering the plurality of candidate signs comprises:
reordering the plurality of candidate signs based on a template matching approach, or
reordering the plurality of candidate signs based on a bilateral matching approach.

6. The method of claim 5, wherein reordering the plurality of candidate signs based on a template matching approach comprises:
reordering the plurality of candidate signs based on a template matching cost between a current template associated with the current video block and a reference template for the current template.

7. The method of claim 6, wherein the template matching cost is determined as a sum of absolute difference (SAD) between the current template and the reference template, or
wherein the template matching cost is determined as a sum of absolute transformed difference (SATD) between the current template and the reference template, or
wherein the template matching cost is determined as a mean removal based sum of absolute difference (MR-SAD) between the current template and the reference template, or
wherein the template matching cost is determined as one of: a weighted average of SAD between the current template and the reference template, a weighted average of MR-SAD between the current template and the reference template, or a weighted average of SATD between the current template and the reference template, or
wherein a cost function for determining the template matching cost comprises one of: SAD, MR-SAD, SATD, mean-removal SATD (MR-SATD), sum of squared differences (SSD), mean-removal SSD (MR-SSD), sum of squared error (SSE), mean removal sum of squared error (MR-SSE) weighted SAD, weighted MR-SAD, weighted SATD, weighted MR-SATD, weighted SSD, weighted MR-SSD, weighted SSE, weighted MR-SSE, or gradient information.

8. The method of claim 1, wherein reordering the plurality of candidate signs comprises:
determining prediction costs for the plurality of candidate signs based on a template matching cost or a bilateral matching cost; and
reordering the plurality of candidate signs ascendingly based on the prediction costs.

9. The method of claim 8, wherein performing the conversion comprises: obtaining a candidate MVD by combining a candidate sign in the reordered plurality of candidate signs with an absolute MVD value; obtaining a candidate MV by adding the candidate MVD to a predicted MV; and performing the conversion based on the candidate MV, or
wherein a target sign used for performing the conversion is a candidate sign with the smallest prediction cost in the reordered plurality of candidate signs, or
wherein a target sign used for performing the conversion is selected from a set of candidate signs at the top N positions in the reordered plurality of candidate signs, where N is an integer.

10. The method of claim 1, wherein performing the conversion comprises: performing the conversion based on the reordered plurality of candidate signs and an MMVD reordering process, or
wherein the MVD is determined based on AMVP, and performing the conversion comprises: performing the conversion based on the reordered plurality of candidate signs and an MMVD reordering process for MMVD, or
wherein the MVD is determined based on affine AMVP, and performing the conversion comprises: performing the conversion based on the reordered plurality of candidate signs and an MMVD reordering process for affine MMVD, or
wherein the MVD is determined based on AMVP and affine AMVP, and performing the conversion comprises: performing the conversion based on the reordered plurality of candidate signs and an MMVD reordering process for MMVD and affine MMVD, or
wherein the MVD is determined based on AMVP, affine AMVP and affine MMVD, and performing the conversion comprises: performing the conversion based on the reordered plurality of candidate signs and an MMVD reordering process for MMVD, or
wherein the MVD is determined based on AMVP, affine AMVP and MMVD, and performing the conversion comprises: performing the conversion based on the reordered plurality of candidate signs and an MMVD reordering process for affine MMVD, or
wherein the MVD is determined based on a first coding tool, and performing the conversion comprises: performing the conversion based on the reordered plurality of candidate signs and an MMVD reordering process for the first coding tool, or
wherein the MVD is determined based on an MVD coding tool other than MMVD, and performing the conversion comprises: performing the conversion based on the reordered plurality of candidate signs and an MMVD reordering process for MMVD.

11. The method of claim 1, further comprising:
determining a first list of MVD candidates and a second list of MVD candidates for bi-prediction of the current video block, the first list being independent from the second list.

12. The method of claim 11, wherein the first list or the second list is indicated in the bitstream, or
wherein the number of MVD candidates in the first list is different from the number of MVD candidates in the second list, or
wherein the number of MVD candidates in the first list and the number of MVD candidates in the second list are predefined, or
wherein the number of MVD candidates in the first list and the number of MVD candidates in the second list are determined on-the-fly, or
wherein the number of MVD candidates in the first list and the number of MVD candidates in the second list are indicated in the bitstream, or
wherein MVD candidates in the first list being independent from MVD candidates in the second list, or
wherein the number of MVD candidates in the first list is non-zero and the number of MVD candidates in the second list is zero, or
wherein the number of MVD candidates in the first list is zero and the number of MVD candidates in the second list is non-zero, or
wherein the first list is associated with a first reference block for the current video block, the second list is associated with a second reference block for the current video block, a distance between the first reference block and the current video block is smaller than a distance between the second reference block and the current video block, the number of MVD candidates in the first list is non-zero and the number of MVD candidates in the second list is zero, or
wherein the first list is associated with a first reference block for the current video block, the second list is associated with a second reference block for the current video block, a distance between the first reference block and the current video block is larger than a distance between the second reference block and the current video block, the number of MVD candidates in the first list is non-zero and the number of MVD candidates in the second list is zero.

13. The method of claim 11, wherein the first list is associated with a first reference direction for the current video block, the second list is associated with a second reference direction for the current video block, a cost of a first MV of the first reference direction is larger than a cost of a second MV of the second reference direction, the number of MVD candidates in the first list is non-zero and the number of MVD candidates in the second list is zero, or
wherein the first list is associated with a first reference direction for the current video block, the second list is associated with a second reference direction for the current video block, a cost of a first MV of the first reference direction is smaller than a cost of a second MV of the second reference direction, the number of MVD candidates in the first list is non-zero and the number of MVD candidates in the second list is zero.

14. The method of claim 13, wherein the cost of the first MV is a template matching cost of the first MV, or
wherein the cost of the first MV is a bilateral matching cost of the first MV.

15. The method of claim 11, wherein the first list is associated with a first reference block for the current video block, the second list is associated with a second reference block for the current video block, the first reference block is ahead of the current video block, the second reference block is after the current video block, the number of MVD candidates in the first list is non-zero and the number of MVD candidates in the second list is zero, or
wherein the first list is associated with a first reference block for the current video block, the second list is associated with a second reference block for the current video block, the first reference block is after the current video block, the second reference block is ahead of the current video block, the number of MVD candidates in the first list is non-zero and the number of MVD candidates in the second list is zero, or
wherein the first list is associated with a first reference block for the current video block, the second list is associated with a second reference block for the current video block, whether the first list or the second list is empty is dependent on a size or an angle of a MV for the first reference block and a size or an angle of a MV for the second reference block, or
wherein at least one of the first list or the second list is converted to MVD candidates for uni-prediction of the current video block, or
wherein information on whether the first list or the second list is empty is determined based on a rate-distortion (RD) and the information is indicated in the bitstream, or
wherein a target MVD pair for performing the conversion comprises a first MVD candidate from the first list and a second MVD candidate from the second list, a position of the first MVD candidate in the first list is different from a position of the second MVD candidate in the second list, or
wherein performing the conversion comprises: determining template costs for a plurality of MVD pairs based on the first list and the second list; and performing the conversion based on a target MVD pair with the smallest template cost, or
wherein each MVD in a target MVD pair for performing the conversion is determined separately, or
wherein a zero MVD is added in to the first list or the second list for MMVD.

16. The method of claim 15, wherein template costs are determined for part of the plurality of MVD pairs, or
wherein a template cost is determined for each of MVD candidates in the first list and the second list.

17. The method of claim 1, wherein the conversion includes encoding the current video block into the bitstream, or
wherein the conversion includes decoding the current video block from the bitstream.

18. An apparatus for processing video data comprising a processor and a non-transitory memory with instructions thereon, wherein the instructions upon execution by the processor, cause the processor to perform acts comprising:
reordering, during a conversion between a current video block of a video and a bitstream of the video, a plurality of candidate signs of a motion vector difference (MVD) for a motion candidate of the current video block; and
performing the conversion based on the reordered plurality of candidate signs.

19. A non-transitory computer-readable storage medium storing instructions that cause a processor to perform acts comprising:
reordering, during a conversion between a current video block of a video and a bitstream of the video, a plurality of candidate signs of a motion vector difference (MVD) for a motion candidate of the current video block; and
performing the conversion based on the reordered plurality of candidate signs.

20. A non-transitory computer-readable recording medium storing a bitstream of a video which is generated by a method performed by a video processing apparatus, wherein the method comprises:
reordering a plurality of candidate signs of a motion vector difference (MVD) for a motion candidate of a current video block of the video; and
generating the bitstream based on the reordered plurality of candidate signs.
